(19) United States
(12) Patent Application Publication
(10) Pub. No.: US 2008/0285870 A1
(43) Pub. Date: Nov. 20, 2008

(54) INFORMATION PROCESSING DEVICE AND METHOD

(75) Inventors: Katsutoshi Ando, Kanagawa (JP); Takahiro Fukuhara, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/114,299

(22) Filed: May 2, 2008

(30) Foreign Application Priority Data
May 17, 2007 (JP) 2007-131866

(51) Int. Cl. G06K 9/36

(52) U.S. Cl. 382/240

(57) ABSTRACT

An information processing device includes: an analysis filtering section that applies to image data an analysis filtering process of decomposing frequency components of the image data into each frequency band by lifting operations; an encoding section that performs an encoding process of encoding the frequency components decomposed into each frequency band by the analysis filtering section; and a control section that controls execution of the encoding process by the encoding section with respect to each of the frequency components, so that the encoding process with respect to each of the frequency components is executed during a period after the analysis filtering process is finished with respect to a plurality of lines of the image data that are inputted, until a plurality of lines of next image data are inputted.

### CROSS REFERENCES TO RELATED APPLICATIONS

The present invention contains subject matter related to Japanese Patent Application JP 2007-131866 filed in the Japanese Patent Office on May 17, 2007, the entire contents of which are incorporated herein by reference.

### BACKGROUND OF THE INVENTION

1. Field of the Invention

The present invention relates to an information processing device and method, and more specifically to an information processing device and method which makes it possible to perform a wavelet transform process and an encoding process efficiently to achieve a reduction in load.

2. Description of the Related Art

As a representative image compression method according to the related art, there is the JPEG (Joint Photographic Experts Group) standardized by the ISO (International Standards Organization). The JPEG uses a discrete cosine transform (DCT), and is known to provide good-quality encoded image and decoded image when relatively high bits are assigned.

In recent years, numerous studies have been made on methods whereby an image is decomposed into a plurality of frequency bands using a filter called a filter bank which is made up of a combination of a high-pass filter and a low-pass filter, and encoding is applied per frequency band. Of those, wavelet transform encoding is regarded as a new promising technique to supersede DCT because the technique is free from block distortion which often becomes a problem in the case of a DCT transform.

The JPEG 2000, of which international standardization was completed in January 2001, adopts a method in which high-efficiency entropy encoding (bit modeling and arithmetic encoding on a bitplane-by-bitplane basis) is combined with the above-mentioned wavelet transform. The JPEG 2000 achieves a significant improvement in encoding efficiency over the JPEG.

A wavelet transform process (see, for example, Japanese Unexamined Patent Application Publication No. 10-283342) is basically performed by inputting image data, and hierarchically decomposing low-frequency components while applying filtering in the horizontal direction and in the vertical direction.

An inverse wavelet transform process is performed to transform coefficient data (frequency components), into which the image data is transformed by the above wavelet transform process, back into the original image data. The inverse wavelet transform process applies a synthesis filtering process to high-frequency components and low-frequency components, starting from the highest decomposition level down to the lowest decomposition level, thereby finally reconstructing an image.

Encoding systems using such a wavelet transform/inverse wavelet transform are frequently used in systems that perform transmission of image data, such as a teleconferencing system or video game system. The following flow of processes is commonly employed in these systems. That is, on the transmitting side, image data is wavelet transformed, and the obtained coefficient data is entropy encoded and transmitted to the receiving side as encoded data. On the receiving side, the acquired encoded data is entropy decoded, and the obtained coefficient data is inverse wavelet transformed to reconstruct the original image data.

In the case of such an image transmission system, it is frequency desired to transmit image data with low delay. Hence, a reduction in delay time is required with respect to individual processes such as the wavelet transform process, entropy encoding, inverse wavelet transform process, and entropy decoding process.

Incidentally, there are software encoders in which an encoder that performs a wavelet transform process and an entropy encoding process is realized by a software program, and software decoders in which a decoder that performs an entropy decoding process and an inverse wavelet transform process is realized by a software program.

In the case of such a software encoder or software decoder, its software program is executed on an information processing device such as a personal computer, thus realizing its function as an encoder or decoder.

### SUMMARY OF THE INVENTION

However, it is commonly the case that a variety of processes are included in an encoder, and the number of these processes is larger than the number of CPUs (Central Processing Units) that execute a software program. That is, in the case of a software encoder, a single CPU executes a variety of processes. In other words, a single arithmetic processing section is shared among a plurality of processes.

Therefore, unless the individual processes for realizing the encoder function are executed in an appropriate manner to ensure efficient performance of these processes, the CPU usage efficiency may decrease, or the memory capacity required for the processes may increase, resulting in an increase in load. An increase in load may also lead to an increase in cost or delay time.

It is thus desirable to efficiently execute a wavelet transform process and an encoding process to thereby reduce the load placed on hardware.

According to an embodiment of the present invention, there is provided an information processing device including: analysis filtering means for applying to image data an analysis filtering process of decomposing frequency components of the image data into each frequency band by lifting operations; encoding means for performing an encoding process of encoding the frequency components decomposed into each frequency band by the analysis filtering means; and control means for controlling execution of the encoding process by the encoding means with respect to each of the frequency components, so that the encoding process with respect to each of the frequency components is executed during a period after the analysis filtering process is finished with respect to a plurality of lines of the image data that are inputted, until a plurality of lines of the next image data are inputted.

The control means may execute the encoding process with respect to each of the frequency components during a period after the analysis filtering process is finished with respect to two lines of the image data that are inputted, until two lines of the next image data are inputted.

The control means may control the encoding process of the encoding means so that, of the respective frequency components decomposed into each frequency band by the analysis filtering means, lower frequency components and, within the same frequency band, frequency components that are generated earlier, are encoded earlier.

The control means may control the encoding process by the encoding means so as to encode frequency components generated earlier than the lowest frequency components generated last by the lifting operations.

The information processing device may further include encoded data holding means for holding encoded data obtained by encoding the frequency components by the encoding means, and the control means may cause encoding to be applied earlier than generation of the lowest frequency components by the lifting operations, to frequency components corresponding to the lowest frequency components and higher than the lowest frequency components.

The control means may cause the encoded data held in the encoded data holding means to be outputted in a predetermined order, after the lowest frequency components are generated, encoded, and outputted.

The control means may control execution of the analysis filtering process by the analysis filtering means with respect to each of the lifting operations so as to execute the lifting operations that can each be executed every time a plurality of lines of the image data are inputted.

The control means may control execution of the analysis filtering process by the analysis filtering means with respect to each of the lifting operations so as to execute the lifting operations that can each be executed every time two lines of the image data are inputted.

Of the lifting operations in the analysis filtering process, lifting operations that generate higher frequency components may be executed earlier.

According to an embodiment of the present invention, there is provided an information processing method including the steps of: applying to image data an analysis filtering process of decomposing frequency components of the image data into each frequency band by lifting operations; performing an encoding process of encoding the frequency components decomposed into each frequency band; and controlling execution of the encoding process with respect to each of the frequency components, so that the encoding process for each of the frequency components is executed during a period after the analysis filtering process is finished with respect to a plurality of lines of the image data that are inputted, until a plurality of lines of the next image data are inputted.

According to the present invention, a wavelet transform process and an encoding process can be performed. In particular, a wavelet transform process and an encoding process can be performed with improved efficiency, thereby making it possible to reduce the load placed on hardware.

### BRIEF DESCRIPTION OF THE DRAWINGS

FIG. 1 is a diagram showing an example of the configuration of an encoding section;

FIG. 2 is a diagram showing an example of the configuration of a decoding section;

FIG. 3 is a simplified diagram schematically illustrating a wavelet transform;

FIG. 4 is a simplified diagram schematically illustrating a wavelet transform;

FIGS. 5A to 5C are simplified diagrams schematically illustrating a wavelet transform;

FIG. 6 is a diagram illustrating an example of how lifting is performed using a 5×3 filter;

FIG. 7 is a diagram illustrating an example of how lifting is performed using a 5×3 filter;

FIG. 8 is a diagram illustrating an example of the flows of an analysis filtering process and synthesis filtering process;

FIG. 9 is a simplified diagram illustrating how respective processes on the encoding side and the decoding side are executed in parallel;

FIG. 10 is a block diagram showing an example of the main configuration of a personal computer;

FIG. 11 is a diagram illustrating an example of the relationship between the flows of a wavelet transform process and entropy encoding process;

FIG. 12 is a schematic diagram illustrating an example of the flow of processes executed in a CPU;

FIG. 13 is a schematic diagram illustrating an example of the flow of processes executed in a CPU;

FIG. 14 is a functional block diagram illustrating an example of the configuration of functions included in a CPU;

FIG. 15 is a flowchart illustrating an example of the flow of a control process;

FIG. 16 is a flowchart continuous from FIG. 15, illustrating an example of the flow of a control process;

FIG. 17 is a diagram illustrating another example of the relationship between the flows of a wavelet transform process and entropy encoding process;

FIG. 18 is a schematic diagram illustrating another example of the flow of processes executed in a CPU;

FIG. 19 is a schematic diagram illustrating another example of the flow of processes executed in a CPU;

FIG. 20 is a functional block diagram illustrating another example of the configuration of functions included in a CPU;

FIG. 21 is a flowchart illustrating an example of the flow of a control process;

FIG. 22 is a schematic diagram illustrating still another example of the flow of processes executed in a CPU;

FIG. 23 is a schematic diagram illustrating still another example of the flow of processes executed in a CPU;

FIG. 24 is a functional block diagram illustrating still another example of the configuration of functions included in a CPU;

FIG. 25 is a flowchart illustrating still another example of the flow of a control process;

FIG. 26 is a flowchart continuous from FIG. 25, illustrating still another example of the flow of a control process;

FIG. 27 is a block diagram showing another example of the main configuration of a personal computer;

FIG. 28 is a schematic diagram illustrating still another example of the flow of processes executed in a CPU;

FIG. 29 is a schematic diagram illustrating still another example of the flow of processes executed in a CPU;

FIG. 30 is a functional block diagram illustrating still another example of the configuration of functions included in a CPU;

FIG. 31 is a flowchart illustrating still another example of the flow of a control process;

FIG. 32 is a flowchart illustrating an example of the flow of an analysis filter control process; and

FIG. 33 is a flowchart illustrating an example of the flow of a reordering/encoding control process.

### DESCRIPTION OF THE PREFERRED EMBODIMENTS

Hereinbelow, an embodiment of the present invention will be described. First, a description will be given of the configuration and operation of an encoding/decoding system using a wavelet transform and an inverse wavelet transform employed in the present invention.

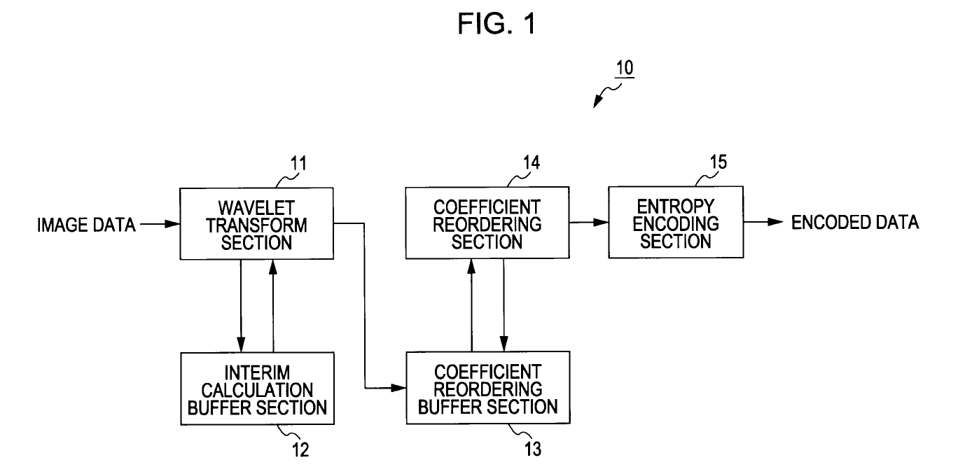

FIG. 1 is a functional block diagram schematically showing functions included in a software encoder that is configured by a software program and encodes image data. An encoding section 10 shown in FIG. 1 is a software encoder which has the functions of a wavelet transform section 11, an intermediate calculation buffer section 12, a coefficient reordering buffer section 13, a coefficient reordering buffer section 14, and an entropy encoding section 15, which are realized by executing a software program by a CPU (Central Processing Unit).

The wavelet transform section 11 applies to image data inputted to the encoding section 10 a wavelet transform process of separating the frequency components of the image data into their frequency bands. Although described later in detail, the wavelet transform section 11 separates frequency components into low- and high-frequency components by an analysis filtering process. Further, the wavelet transform section 11 repeats the analysis filtering process recursively with respect to the obtained low-frequency components, thus hierarchically decomposing the frequency components into frequency bands. It should be noted that in the following description, these frequency components are refereed to as wavelet coefficients, wavelet coefficient data, coefficient data, or coefficients. Also, in the following description, each hierarchical level into which frequency components are decomposed is referred to as decomposition level.

When repeating the analysis filtering process, the wavelet transform section 11 causes the intermediate calculation buffer section 12 to hold the coefficient data or image data to be used for the next analysis filtering process as intermediate calculation data. That is, the wavelet transform section 11 reads intermediate calculation data (image data or coefficient data) held in the intermediate calculation buffer section 12, and uses the intermediate calculation data to perform a wavelet transform process on externally inputted image data.

The wavelet transform section 11 writes the high-frequency components (coefficient data) obtained at each decomposition level, and the low-frequency components (coefficient data) at a predetermined final decomposition level (highest level) into the coefficient reordering buffer section 13.

The coefficient reordering section 14 reads the coefficient data written into the coefficient reordering buffer section 13 in a predetermined order, and supplies the read coefficient data to the entropy encoding section 15. Although will be described later in detail, the order in which pieces of coefficient data are generated in the wavelet transform process differs from the order of their use in the inverse wavelet transform process. Accordingly, the coefficient reordering section 14 reads pieces of coefficient data from the coefficient reordering buffer section 13 in the order of their use in the inverse wavelet transform process, thereby reordering the pieces of coefficient data.

The entropy encoding section 15 quantizes the supplied coefficient data by a predetermined method, for example, in accordance with a predetermined entropy encoding scheme such as Huffman encoding or arithmetic encoding. That is, the entropy encoding section 15 encodes pieces of coefficient data in the order of their use in the inverse wavelet transform process. The entropy encoding section 15 outputs the generated encoded data to the external of the encoding section 10.

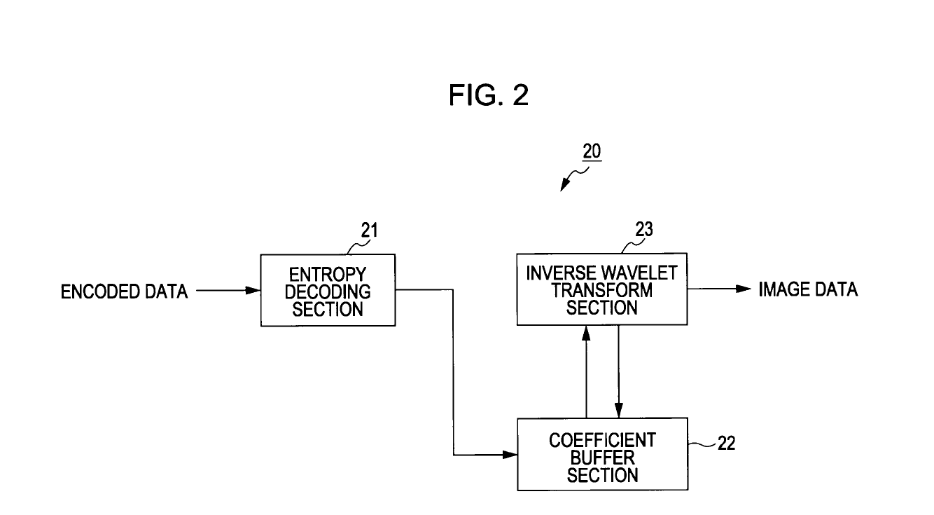

FIG. 2 is a functional block diagram schematically showing functions of a software decoder configured by a software program and corresponding to the encoding section 10 shown in FIG. 1. A decoding section 20 is a processing section that decodes encoded data obtained by encoding image data in the encoding section 10 to thereby reconstruct the image data. The decoding section 20 has the functions of an entropy decoding section 21, a coefficient buffer section 22, and an inverse wavelet transform section 23.

When encoded data is inputted, the entropy decoding section 21 performs entropy decoding on the inputted encoded data by a method corresponding to the method used in the entropy encoding section 15 shown in FIG. 1, thus reconstructing coefficient data. The entropy decoding section 21 causes the coefficient buffer section 22 to hold the obtained coefficient data. The inverse wavelet transform section 23 performs an inverse transform process of the wavelet transform process performed by the wavelet transform section 11 shown in FIG. 1, thus reconstructing the original image data.

That is, with respect to the frequency components hierarchically decomposed by the wavelet transform section 11, the inverse wavelet transform section 23 performs a synthesis filtering process of synthesizing low- and high-frequency components in order from the highest decomposition level, and progressively lowers the decomposition level for frequency components by one, thus finally reconstructing image data of the baseband. The inverse wavelet transform section 23 outputs the generated image data to the external of the encoding section 20.

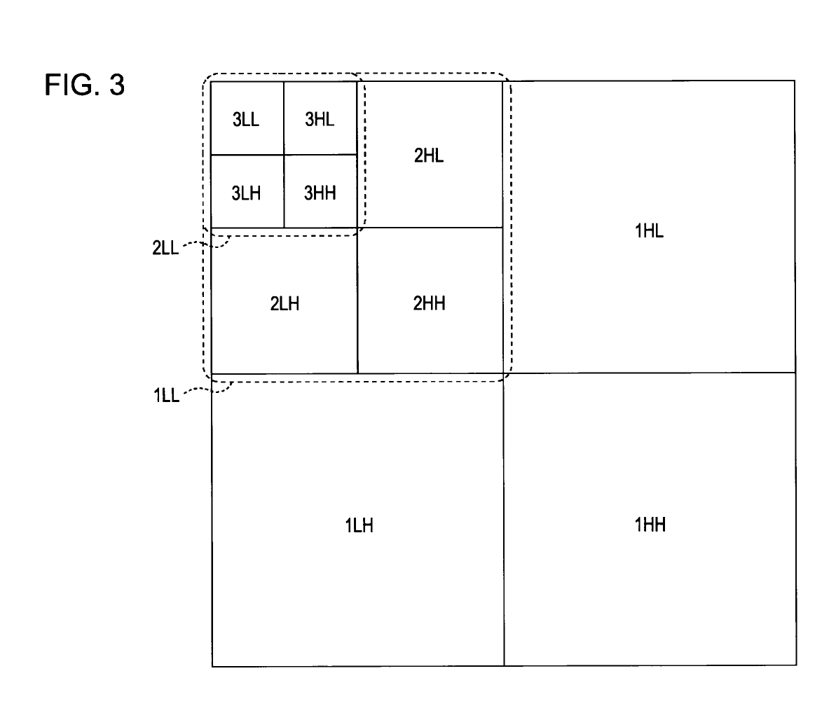

Next, a description will be given of a wavelet transform process employed in a system using the encoding section 10 and the decoding section 20 as described above. As is schematically shown in FIG. 3, in a wavelet transform applied to image data, a process of decomposing image data into high and low bands of spatial frequencies is repeated recursively with respect to data of low spatial frequency bands obtained as a result of the decomposition.

Analysis filters include a horizontal analysis filter that applies an analysis filtering process on image data in the horizontal direction of the screen, and a vertical analysis filter that applies an analysis filtering process on image data in the vertical direction of the screen. By performing an analysis filtering process once in each of the directions, image data is decomposed into four frequency bands (subbands). The wavelet transform section 11 recursively repeats the above-described analysis filtering processes in the horizontal direction and in the vertical direction with respect to low spatial frequency bands of the analysis filtering results in both the horizontal and vertical directions (that is, the wavelet transform section 11 applies hierarchical decomposition).

FIG. 3 is a diagram schematically showing a case where an analysis filtering process has been repeated three times. In the example shown in FIG. 3, analysis filtering processes in the horizontal direction and the vertical direction are recursively repeated three times, thus decomposing the frequency components (coefficient data) of one picture of image data into ten hierarchical subbands.

In FIG. 3, each square indicated by solid lines and each rounded-corner square indicated by dotted lines represent a subband generated by an analysis filtering process. The numeral written in each subband denotes the hierarchy level (decomposition level) of the subband. That is, the numeral indicates the number of times an analysis filtering process is performed on baseband mage data to obtain the subband in question. Further, “L” and “H” written in each subband represent low- and high-frequency components, respectively. The results of an analysis filtering process in the horizontal direction are shown on the left-hand side, and the results of an analysis filtering process in the vertical direction are shown on the right-hand side.

In the example shown in FIG. 3, the first analysis filtering process is applied to baseband image data to generate four subbands at decomposition level 1 (1LL, 1LH, 1HL, and 1HH). Of the generated subbands, the second analysis filtering process is applied to the subband “1LL” of low-frequency components with respect to both the horizontal direction and the vertical direction, thus generating four subbands at decomposition level 2 (2LL, 2LH, 2HL, and 2HH). The third analysis filtering process is applied to the subband “2LL” of the generated subbands which includes low-frequency components with respect to both the horizontal direction and the vertical direction, thus generating four subbands at decomposition level 3 (3LL, 3LH, 3HL, and 3HH).

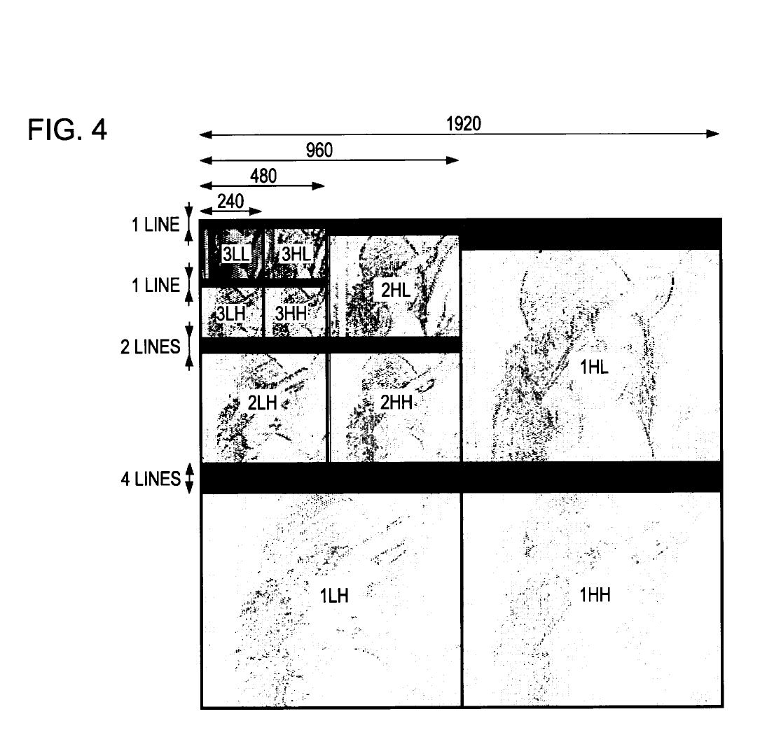

The reason why transforms and decompositions are iterated with respect to low-frequency components is because, as shown in FIG. 4, the energy of an image is concentrated in low-frequency components in subbands of higher levels (lower-frequency components). In this way, by performing the analysis filtering process recursively to generate hierarchical subbands, and narrowing down data of low spatial frequency bands into smaller areas, efficient compression encoding can be performed when performing entropy encoding.

It should be noted that in the following description, of the four subbands generated by an analysis filtering process, the subband “LL”, which is a subband with low-frequency components with respect to both the horizontal direction and the vertical direction and on which an analysis filtering process is performed again, is referred to as a low-frequency subband, and the other subbands “LH”, “HL”, and “HH” on which no further analysis filtering process is performed are each referred to as a high-frequency subband.

While it is possible to perform the above-mentioned wavelet transform process at once with respect to the entire picture, it is also possible to split one picture of image data in several lines, and apply a wavelet transform process to each of the several lines of image data independently from each other. Since the amount of image data to be processed in a single wavelet transform process is smaller in the latter case than in the former case, the timing of starting the output of the results of a wavelet transform process can be made earlier. That is, a load or delay time due to a wavelet transform process can be reduced.

It should be noted that the number of lines constituting the processing unit of a wavelet transform process is based on the number of lines required for obtaining one line of coefficient data of the highest-level subband, at a predetermined decomposition level of a wavelet transform process.

Since data is decomposed into four parts by an analysis filtering process, as shown in FIG. 4, the number of lines that is four lines at decomposition level 1 becomes two lines at decomposition level 2, and becomes one line at decomposition level 3. That is, the number of lines halves each time the decomposition level increases by one. In other words, in the case of a wavelet transform process at decomposition level 3, to obtain one line of coefficient data of the highest-level subbands (3LL, 3LH, 3HL, and 3HH), eight lines of baseband image data are necessary. Accordingly, in this case, a wavelet transform process is performed with eight or more lines of baseband image data as the processing unit.

A collection of pieces of baseband pixel data required for generating one line of coefficient data of the low-frequency subband “LL” of the highest level, or a collection of pieces of coefficient data obtained from the image data is referred to as precinct (or line block).

It should be noted that as shown in FIG. 4, the number of pieces of data in the horizontal direction halves each time the decomposition level increases by one. That is, in a case where the number of pixels in the horizontal direction of baseband image data is 1920, the number of pieces of data in the horizontal direction of the coefficient data at decomposition level 1 becomes 960, the number of pieces of data in the horizontal direction of the coefficient data at decomposition level 2 becomes 480, and number of pieces of data in the horizontal direction of the coefficient data at decomposition level 3 becomes 240.

A wavelet transform process and an inverse wavelet transform process are basically performed with this precinct, rather than the entire picture, as the processing unit. That is, one picture of image data is decomposed into a plurality of precincts each made up of a plurality of lines, and processing is executed in a plurality of times on a precinct by precinct basis. Hence, basically, a wavelet transform process and an inverse wavelet transform process are completed on a precinct by precinct basis. For example, when the wavelet transform process is performed with respect to one precinct of baseband image data, a set of pieces of coefficient data whose lowest-frequency component (coefficient data of the highest decomposition level) is made up of at least one line and which are hierarchically decomposed into individual frequency bands is obtained. When the inverse wavelet transform process is performed on the set of pieces of coefficient data, the original one precinct of baseband image data is obtained.

By performing the wavelet transform process and the inverse wavelet transform process per precinct that is a finer unit than a picture in this way, the amount (accumulation amount) of image data or coefficient data to be accumulated for performing a wavelet transform process or an inverse wavelet transform process can be reduced. That is, the transformed coefficient data or image data can be outputted at an earlier timing, thereby making it possible to reduce a load or delay time due to a wavelet transform process or an inverse wavelet transform process.

While it may be also possible to split each line of image data into a plurality of blocks and perform a wavelet transform process or an inverse wavelet transform process by using each of these blocks as the processing unit. In that case, however, control must be performed in even finer units than required by the horizontal synchronization timing. Thus, as compared with a case where a precinct is used as the processing unit, the control may become high-speed and complicated, resulting in an increase in load. Further, the smallest number of lines constituting a block is restricted in accordance with the decomposition level as in the case of a precinct. Since one picture of image data is supplied on a line by line basis in order from the top line on the screen, in the case where a block is used as the processing unit as well, it is necessary to accumulate substantially the same amount of image data or coefficient data as that required in the case where a precinct is used as the processing unit. Therefore, there is virtually no difference in terms of the delay time of a wavelet transform process or an inverse wavelet transform process between the two cases.

It should be noted that the number of lines constituting one precinct may not be the same among individual precincts.

For a wavelet transform, for example, an analysis filter such as a 5×3 filter or 9×7 filter is used. A method using a 5×3 filter is also adopted in the JPEG 2000 standard, and proves advantageous in that a wavelet transform can be performed with a small number of filter taps.

As represented by Equation (1) and Equation (2) below, the impulse response (Z-transform representation) of a 5×3 filter is made up of a low-pass filter H₀ (x) and a high-pass filter H₁ (z). It is to be appreciated that H₀ (x) is a five-tap filter, and H₁ (z) is a three-tap filter.

H₀(z)=(−1+2z⁻¹+6z⁻²+2z⁻³−z⁴)/8 (1)

H₁(z)=(−1+2z⁻¹−z⁻²)/2 (2)

According to Equation (1) and Equation (2) above, coefficients of low-frequency and high-frequency components can be directly calculated. The most common computing method employed for such an analysis filtering process using a filter is a method called convolution. This convolution is the most basic means for realizing a digital filter, and involves multiplying the tap coefficients of a filter by the actual input data. However, since this convolution causes an increase in calculation load in accordance with the tap length, there is a method of performing computation of a filtering process by using the lifting technique described in a dissertation “W. Swelden, “The lifting scheme: A custom-design construction of Biorthogonal wavelets.”, Appl. Comput. Harmon. Anal., vol 3, no. 2, pp. 186-200, 1996)”.

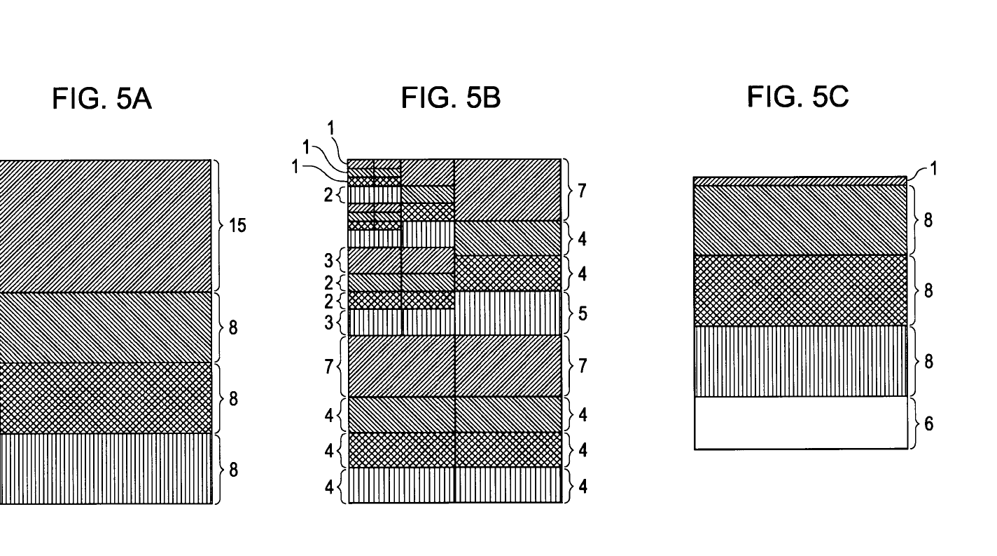

FIGS. 5A to 5C are simplified diagrams showing how data changes due to a wavelet transform process and an inverse wavelet transform process. FIG. 5A schematically shows baseband image data to be wavelet-transformed. FIG. 5B schematically shows coefficient data obtained by performing a wavelet transform on the image data shown in FIG. 5A at decomposition level 3. FIG. 5C schematically shows baseband image data obtained by performing a wavelet inverse transform on the coefficient data shown in FIG. 5B.

In FIGS. 5A to 5B, the areas represented by individual patterns each indicate a precinct. In FIGS. 5A to 5C, precincts of the same pattern represent mutually corresponding precincts. For example, when baseband image data indicated by diagonal lines sloping downward from right to left in FIG. 5A is wavelet transformed, pieces of coefficient data that are hierarchically decomposed into individual frequency band as indicated by diagonal lines sloping downward from right to left in FIG. 5B are generated. Further, when an inverse wavelet transform is performed on those pieces of coefficient data, baseband image data indicated by diagonal lines sloping downward from right to left in FIG. 5C is obtained. It should be noted that for the simplicity of description, in FIGS. 5A to 5C, the number of lines constituting one picture is assumed to be 31.

Although described later in detail, as shown in FIG. 5A, when performing computation of a filtering process by using the lifting technique, generally, the precinct at the top of the picture requires a larger number of lines than precincts from the second precinct from the top and onwards. Further, as shown in FIG. 5B, when computation of a filtering process is performed using the lifting technique, generally, the precinct at the top and the precinct at the bottom of a picture differ from the other precincts in the number of lines of coefficient data at each decomposition level.

Further, in a case where computation of a filtering process is performed by using the lifting technique, as shown in FIGS. 5A and 5C, when baseband image data is wavelet transformed and then further inverse wavelet transformed, baseband image data whose line numbers differ from the line numbers prior to the transform is reconstructed. That is, the line numbers of baseband image data differ between a precinct at the time of wavelet transform and a precinct at the time of inverse wavelet transform corresponding to that precinct.

Further, in the case of the precinct at the top of a picture, the number of lines differs between baseband image data prior to the wavelet transform and baseband image data obtained after the inverse wavelet transform. Therefore, as shown in FIGS. 5A and 5C, when baseband image data is wavelet transformed and then further inverse wavelet transformed, the number of lines decreases. Therefore, to reconstruct image data with 31 lines as shown in FIG. 5C, image data with more than 31 lines must be wavelet transformed as shown in FIG. 5A. That is, at the time of wavelet transform, dummy data is added to baseband image data. It should be noted that dummy data is also used in an inverse wavelet transform process in order to reconstruct the image data of the precinct at the bottom of the picture shown in FIG. 5C.

Next, the lifting technique will be described.

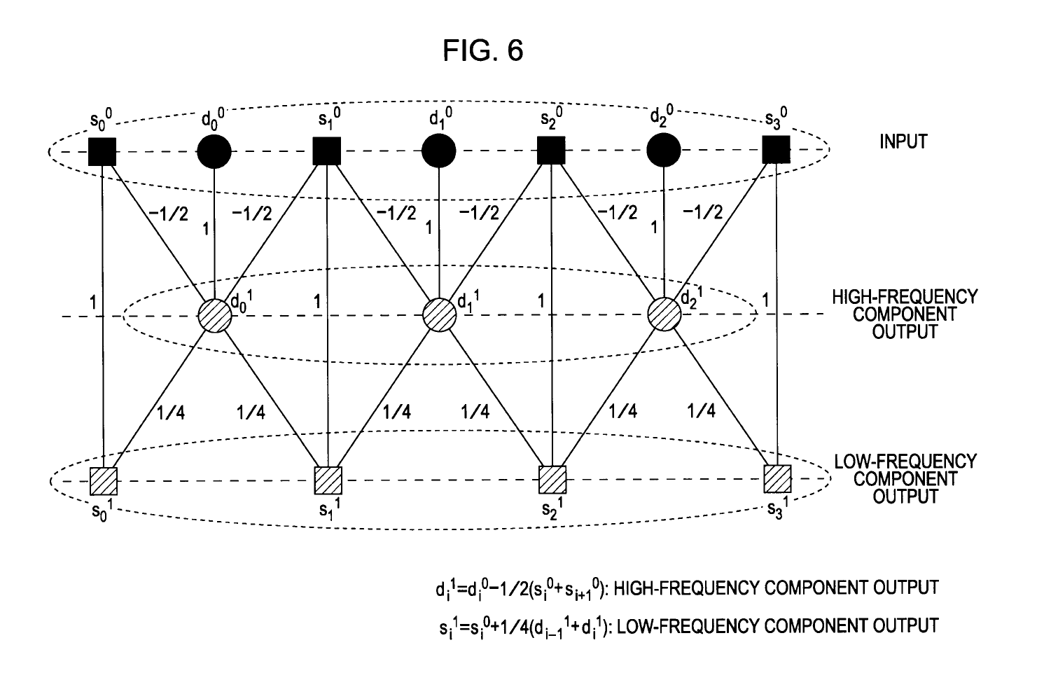

FIG. 6 illustrates a case where lifting with a 5×3 filter is employed. This filtering method will be described below.

In FIG. 6, the uppermost part, the middle part, and the lowermost part show a row of input image pixels, high-frequency component outputs, and low-frequency component outputs, respectively. Shown in the uppermost part is not limited to a row of input image pixels but may be coefficients obtained by the filtering process described above. Here, it is assumed that the uppermost part shows a row of input image pixels, and each square mark (▪) represents an even-numbered (starting at 0) pixel or line, and each circle mark () represents an odd-numbered pixel or line.

As the first stage, high-frequency component coefficients dᵢ¹ are generated from the input pixel row by Equation (3) below.

dᵢ¹=dᵢ⁰−½(sᵢ⁰+sᵢ₊₁⁰) (3)

Next, as the second stage, by using the thus generated high-frequency component coefficients, and odd-numbered pixels of an input image, low-frequency component coefficients sᵢ¹ are generated by Equation (4) below.

sᵢ¹=sᵢ⁰+¼(dᵢ₋₁¹+dᵢ¹) (4)

On the analysis filter side, the pixel data of an input image is decomposed into low-frequency components and high-frequency components through a filtering process in this way.

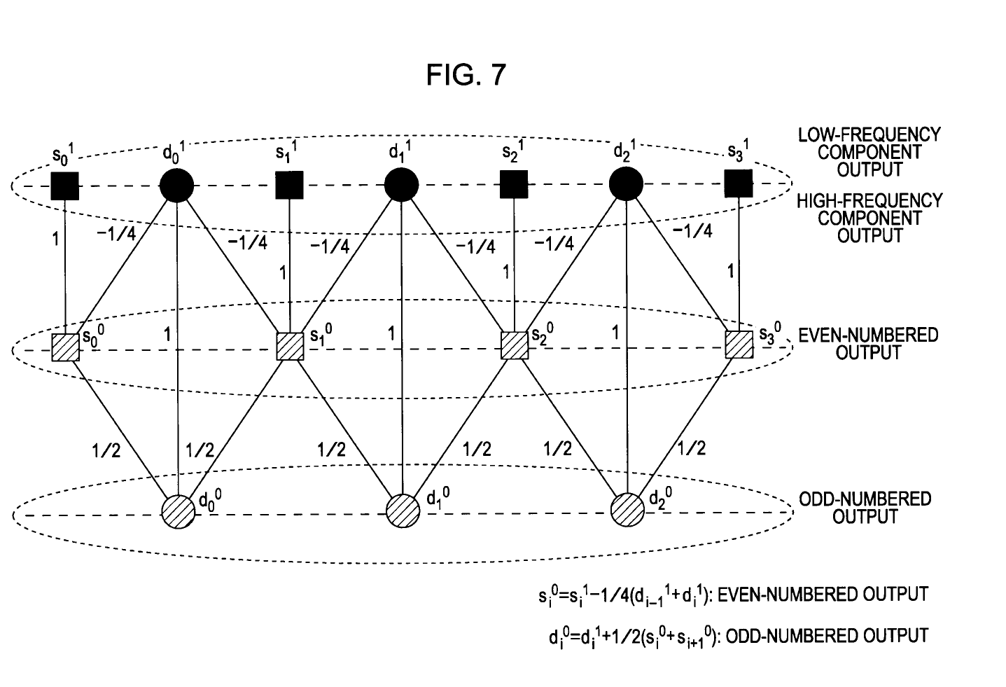

Next, referring to FIG. 7, a description will be schematically given of the process at a synthetic filter that performs an inverse wavelet transform for reconstructing coefficients generated by the above-described wavelet transform. FIG. 7 corresponds to FIG. 6 described above, and illustrates a case where the lifting technique is applied by using a 5×3 filter. In FIG. 7, the uppermost part shows input coefficients generated by a wavelet transform, and each circular mark () and square mark (▪) indicate a high-frequency component coefficient and a low-frequency component coefficient, respectively.

As the first stage, in accordance with Equation (5) below, even-numbered (starting at 0) coefficients sᵢ⁰ are generated from the input coefficients of low-frequency and high-frequency components.

sᵢ⁰=sᵢ¹−¼(dᵢ₋₁¹dᵢ¹) (5)

Next, as the second stage, in accordance with Equation (6) below, odd-numbered coefficients dᵢ⁰ are generated from the even-numbered coefficient sᵢ⁰ generated in the first stage described above, and input high-frequency component coefficients dᵢ⁰.

dᵢ⁰=dᵢ¹+½(sᵢ⁰+sᵢ₊₁⁰) (6)

On the synthesis filter side, coefficients of the low-frequency and high-frequency components are synthesized by the filtering process in this way to perform an inverse wavelet transform.

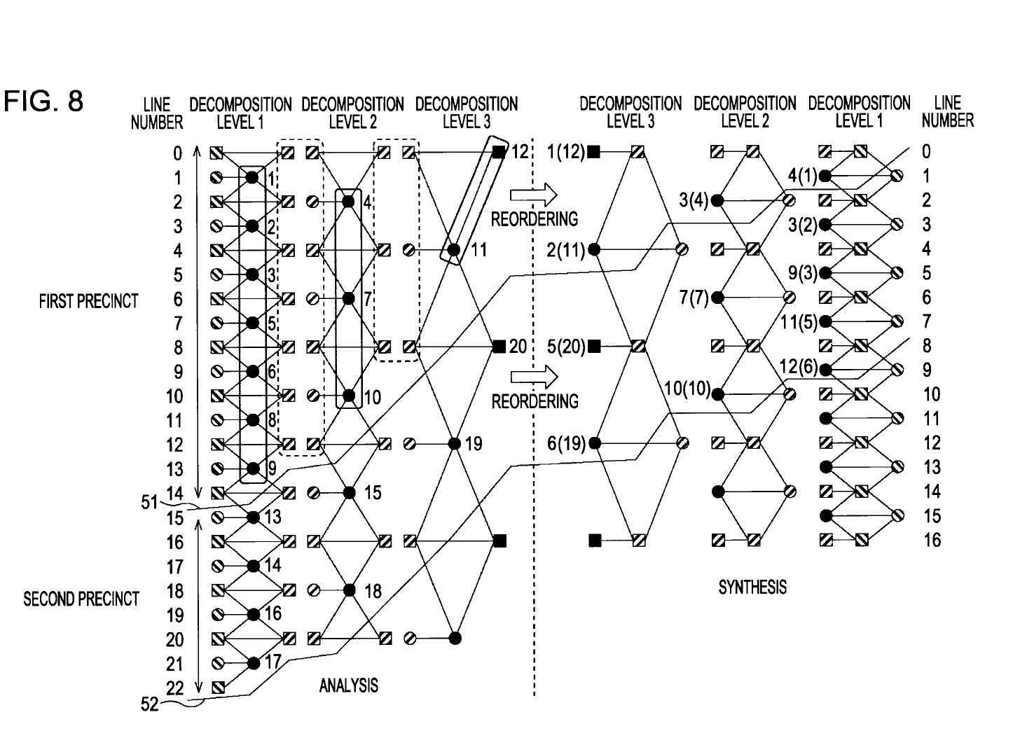

FIG. 8 is a schematic diagram showing an analysis filtering process and a synthesis filtering process when filtering based on lifting with a 5×3 filter is executed down to decomposition level 3. The left side in FIG. 8 shows a lifting operation in the analysis filtering process, and the right side in FIG. 8 shows a lifting operation in the synthesis filtering process.

More specifically, circles and squares in FIG. 8 show image data or coefficient data. Each of lines connecting between these circles and squares shows the relationship between pieces of image data or coefficient data in a lifting operation. That is, in FIG. 8, every three rows of circles and squares represent a single lifting operation. Of the three rows, a circle or square in the leftmost row represents input data of a lifting operation, and circles and squares in the center row and in the rightmost row represent output data of the lifting operation. When the lifting operation is applied to each input data, output data connected to the input data by a line is generated. In other words, each output data is generated by using input data that is connected to the output data by a line.

On the left side of a vertical dotted line located at the center of FIG. 8, circles, squares, and lines connecting between those circles and squares in the first to third rows from the left represent a lifting operation of an analysis filtering process at decomposition level 1, circles, squares, and lines connecting between the circles and squares in the fourth to sixth rows from the left represent a lifting operation of an analysis filtering process at decomposition level 2, and circles, squares, and lines connecting between the circles and squares in the seventh to ninth rows from the left represent a lifting operation of an analysis filtering process at decomposition level 3. On the right side of the vertical dotted line located at the center of FIG. 8, circles, squares, and lines connecting between those circles and squares in the first to third rows from the left represent a lifting operation of an analysis filtering process at decomposition level 3, circles, squares, and lines connecting between the circles and squares in the fourth to sixth rows from the left represent a lifting operation of an analysis filtering process at decomposition level 2, and circles, squares, and lines connecting between the circles and squares in the seventh to ninth rows from the left represent a lifting operation of an analysis filtering process at decomposition level 1.

In FIG. 8, circles indicated by patterns of diagonal lines sloping upward from left to right represent lines whose line numbers are odd numbers (odd-numbered lines), and squares indicated by patterns of diagonal lines sloping upward from left to right represent lines whose line numbers are even numbers (even-numbered lines). It should be noted that the line number is incremented from the top to the bottom lines, with the line at the top of an image being “0”.

Further, in FIG. 8, circles and squares indicated by patterns of diagonal line sloping downward from left to right respectively represent odd-numbered coefficients and even-numbered coefficients for intermediate calculation, which are used in intermediate calculation of a lifting operation. In FIG. 8, each black circle () and block square (▪) represent a high-frequency component and a low-frequency component (frequency components) obtained as a result of the lifting operation.

It should be noted that in FIG. 8, for the simplicity of description, only a filtering process with respect to the vertical direction is illustrated, and an analysis filtering process and a synthetic filtering process with respect to the horizontal direction are omitted.

A more specific description will be given in this regard. On the left side of the vertical dotted line at the center of FIG. 8, when pieces of image data shown in the first row from the left are inputted, the wavelet transform section 11 performs an analysis filtering process (lifting operation) at decomposition level 3 on those pieces of data, generating high-frequency components at decomposition level 1 shown in the second row from the left and low-frequency components at decomposition level 1 shown in the third row from the left. The high-frequency components at decomposition level 1 shown in the second row from the left are not subjected to any further analysis filtering process, and are supplied to the coefficient reordering buffer section 13 and held therein. The low-frequency components at decomposition level 1 shown in the third row from the left are supplied as intermediate calculation data to the intermediate calculation buffer section 12 and held therein to perform an analysis filtering process again.

Next, the wavelet transform section 11 performs an analysis filtering process (lifting operation) at decomposition level 2 on the intermediate calculation data held in the intermediate calculation buffer section 12, as shown in the fourth to sixth rows from the left on the left side of the vertical dotted line at the center of FIG. 8. Circles and squares in the fourth row from the left each represent the same coefficient data as the square in the same column of the third row from the left. Each circle represents coefficient data of an odd-numbered line, and each square represents coefficient data of an even-numbered line.

The wavelet transform section 11 performs an analysis filtering process (lifting operation) at decomposition level 2 on coefficient data shown in the fourth row from the left, generating high-frequency components at decomposition level 2 shown in the fifth row from the left and low-frequency components at decomposition level 2 shown in the sixth row from the left. The high-frequency components at decomposition level 2 shown in the fifth row from the left are not subjected to any further analysis filtering process, and are supplied to the coefficient reordering buffer section 13 and held therein. The low-frequency components at decomposition level 2 shown in the sixth row from the left are supplied as intermediate calculation data to the intermediate calculation buffer section 12 and held therein to perform an analysis filtering process again.

Next, the wavelet transform section 11 performs an analysis filtering process (lifting operation) at decomposition level 3 on the intermediate calculation data held in the intermediate calculation buffer section 12, as shown in the seventh to ninth rows from the left on the left side of the vertical dotted line at the center of FIG. 8. Circles and squares in the seventh row from the left each represent the same coefficient data as the square in the same column of the sixth row from the left. Each circle represents coefficient data of an odd-numbered line, and each square represents coefficient data of an even-numbered line.

The wavelet transform section 11 performs an analysis filtering process (lifting operation) at decomposition level 3 on coefficient data shown in the seventh row from the left, generating high-frequency components at decomposition level 3 shown in the eighth row from the left and low-frequency components at decomposition level 3 shown in the ninth row from the left. The decomposition level 3 is set in advance as the highest level beyond which no further filtering process is performed. Accordingly, both the high-frequency components at decomposition level 3 shown in the eighth row from the left, and the low-frequency components at decomposition level 3 shown in the ninth row from the left are supplied to the coefficient reordering buffer section 13 and held therein.

That is, on the left side of the vertical dotted line at the center of the FIG. 8, the dotted rounded-corner square surrounding coefficient data in the third and fourth rows from the left, and the dotted rounded-corner squares surrounding coefficient data in the fifth and sixth rows from the left represent the intermediate calculation buffer section 12, and the solid rounded-corner squares surrounding coefficient data in the second, fifth, eighth, and ninth rows from the left represent the coefficient reordering buffer section 13.

As described above, the wavelet transform section 11 performs a lifting operation through a wavelet transform process in order from decomposition level 1 to decomposition 3, thus generating coefficient data of individual decomposition levels in order from higher to lower frequencies. However, although described later in detail, since image data is inputted per one line in actuality, the wavelet transform section 11 can perform a lifting operation every time two lines of image data are inputted. That is, in some cases, inputted image data or coefficient data held in the coefficient reordering buffer section 13 is used for the next lifting operation. Accordingly, such image data is used not only for a lifting operation at the time of its input but is also held in the intermediate calculation buffer section 12 as intermediate calculation data and used for a lifting operation performed when the next line is inputted. Likewise, coefficient data is not only held in the coefficient reordering buffer section 13 but is also held in the intermediate calculation buffer section 12 as intermediate calculation data and used for a lifting operation performed later.

Through the above-described lifting operation, the wavelet transform section 11 generates pieces of coefficient data (black circle () and black square (▪)) obtained as a result of the lifting operation, in the order of the numbers attached to the left of the respective pieces of coefficient data.

On the other hand, on the right side of the vertical dotted line at the center of FIG. 8, a lifting operation in the synthesis filtering process by the inverse wavelet transform section 23 is shown.

On the right side of the vertical dotted line at the center of FIG. 8, each piece of coefficient data (black circle () and black square (▪)) shown in the first row from the left is the same data as the piece of coefficient data of the same column as its own in the eighth or ninth row from the left on the left side of the vertical dotted line at the center of FIG. 8. That is, the inverse wavelet transform section 23 performs a synthesis filtering process (lifting operation) at decomposition level 3 of synthesizing low-frequency components (black square (▪)) and high-frequency components (black circle ()) at decomposition level 3 shown in the first row from the left on the right side of the vertical dotted line at the center of FIG. 8, generating coefficient data of even-numbered lines of low-frequency components at decomposition level 2 shown in the second row from the left, and coefficient data of odd-numbered lines of low-frequency components at decomposition level 2 shown in the third row from the left.

The inverse wavelet transform section 23 performs a lifting operation (synthesis filtering process at decomposition level 2) again with respect to the low-frequency components at decomposition level 2 shown in the second and third rows from the left, and high-frequency components at decomposition level 2 that are newly supplied (the fourth to sixth rows from the left). Each square indicated by the pattern of diagonal lines sloping upward from left to right in the fourth row from the left represents the same coefficient data as the square of the same column as its own in the second row from the left or the circle in the third row from the left. Further, each black circle () in the fourth row from the left represents the same coefficient data as the black circle () of the same column as its own in the fifth row from the left on the left side of the vertical dotted line at the center of FIG. 8, that is, a high-frequency component at decomposition level 2 that is newly supplied.

The inverse wavelet transform section 23 performs a synthesis filtering process (lifting operation) at decomposition level 2 of synthesizing low-frequency components and high-frequency components at decomposition level 2 shown in the fourth row from the left on the right side of the vertical dotted line at the center of FIG. 8, generating coefficient data of even-numbered lines of low-frequency components at decomposition level 1 shown in the fifth row from the left, and coefficient data of odd-numbered lines of low-frequency components at decomposition level 1 shown in the sixth row from the left.

The inverse wavelet transform section 23 performs a lifting operation (synthesis filtering process at decomposition level 1) again with respect to the low-frequency components at decomposition level 1 shown in the fifth and sixth rows from the left, and high-frequency components at decomposition level 1 that are newly supplied (the seventh to ninth rows from the left). Each square indicated by the pattern of diagonal lines sloping upward from left to right in the seventh row from the left represents the same coefficient data as the square in the fifth row from the left or the circle in the sixth row from the left that is in the same column as the square itself. Further, each of black circles () in the seventh row from the left represents the same coefficient data as the black circle () of the same column as its own in the seventh row from the left on the left side of the vertical dotted line at the center of FIG. 8, that is, a high-frequency component at decomposition level 1 that is newly supplied.

The inverse wavelet transform section 23 performs a synthesis filtering process (lifting operation) at decomposition level 1 of synthesizing low-frequency components and high-frequency components at decomposition level 1 shown in the seventh row from the left on the right side of the vertical dotted line at the center of FIG. 8, generating even-numbered lines of baseband image data shown in the eighth row from the left, and off-numbered lines of baseband image data shown in the ninth row from the left.

From the relationship between the lifting operations in the analysis filtering process and synthesis filtering process as described above, precincts are partitioned as indicated by a curved line 51 and a curved line 52. That is, at the time of a wavelet transform, image data of the first precinct that is the precinct at the top of a picture requires 15 lines from line number 0 to line number 14, and image data of the second precinct that is the second precinct from the top of the picture requires 8 lines from line number 15 to line number 22. In actuality, as shown in FIG. 8, image data and coefficient data of the first precinct are also used in the analysis filtering process of the second precinct.

Further, at the time of an inverse wavelet transform, 1 line of image data of line number 0 is generated from coefficient data of the first precinct, and 8 lines of image data from line number 1 to line number 8 are generated from coefficient data of the second precinct. In actuality, as shown in FIG. 8, image data and coefficient data of the first precinct are also used in the analysis filtering process of the second precinct.

On the right side of the vertical dotted line at the center of FIG. 8, numbers attached to the left of black circles () and black squares (▪) indicate the order in which the respective pieces of coefficient data are used in the synthesis filtering process. Numbers in brackets by the side of the above-mentioned numbers indicate the order in which the respective pieces of coefficient data are generated in the analysis filtering process. That is, the numbers in brackets shown on the right side of the vertical dotted line at the center of FIG. 8 correspond to the numbers shown on the left side of the vertical dotted line at the center of FIG. 8.

That is, the order in which pieces of coefficient data are generated in the analysis filter, and the order in which pieces of coefficient data are used in the synthesis filter are different from each other. Accordingly, as indicated by hollow arrows at the center of FIG. 8, pieces of coefficient data generated in the analysis filtering process must be reordered in their order before being subjected to the synthesis filtering process.

The coefficient reordering section 14 reads pieces of coefficient data held in the coefficient reordering buffer section 13, in the order of their use in the synthesis filtering process to thereby reorder the pieces of coefficient data. That is, the entropy encoding section 15 encodes the pieces of coefficient data in the order of their use in the synthesis filtering process.

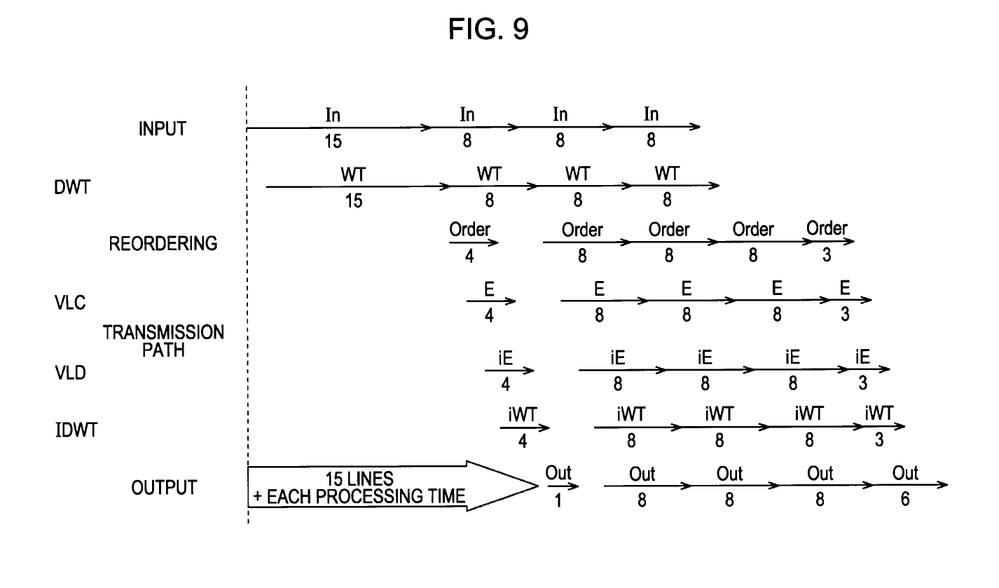

The encoding section 10 and the decoding section 20 execute their respective processes in parallel with each other, as schematically shown in FIG. 9. That is, as indicated by arrows in FIG. 9, processes such as the input of image data, a wavelet transform (DWT), reordering of coefficients, and entropy encoding (VLC) performed by the encoding section 10, and processes such as the entropy decoding (VLD), an inverse wavelet transform (IDWT), and output of image data performed by the decoding section 20 are executed in parallel with each other. Each arrow indicates a process with respect to one precinct, and a number shown below each arrow indicates the number of lines processed in the process indicated by the arrow. For example, in the case of the first precinct indicated by the leftmost arrow in each process, 15 lines of image data are inputted, which are wavelet-transformed into 4 lines of coefficient data and encoded, and further decoded and then inverse wavelet transformed before being outputted as 1 line of image data. This matches the description given above with reference to FIG. 8.

By performing processes in parallel in this way, the delay time from the input to the output can be set to the sum of the time corresponding to 15 lines and the processing time of each process. In contrast, in a case where a wavelet transform is performed with respect to, for example, the whole of one picture, a delay time corresponding to one picture or more occurs. Accordingly, by performing the respective processes on a precinct by precinct basis, and also executing the respective processes in parallel with each other as shown in FIG. 9, the delay time from the input to output can be significantly reduced.

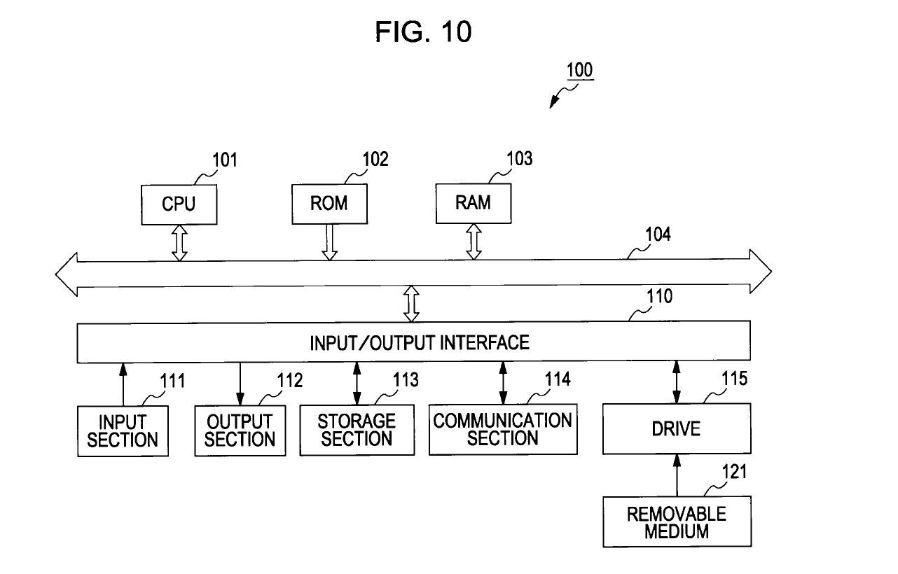

However, in the case of a software encoder or software decoder, the software encoder or software decoder is realized by a software program being executed in a personal computer as shown in FIG. 10.

FIG. 10 is a block diagram showing an example of the configuration of a personal computer.

In FIG. 10, a CPU 101 of a personal computer 100 is an arithmetic processing section that executes various processes by executing software programs. The CPU 101 is interconnected with a ROM (Read Only Memory) 102 and a RAM (Random Access Memory) 103 via a bus 104 that is a common bus. Software programs and data are stored in the ROM 102 in advance. Software programs and data stored in the ROM 102 and a storage section 113 are loaded into the RAM 103. Data and the like necessary for the CPU 101 to execute various processes are also stored in the RAM 103 as appropriate.

The CPU 101, the ROM 102, and the RAM 103 are connected to each other via the bus 104. An input/output interface 101 is also connected to the bus 104.

Connected to the input/output interface 110 is an input section 111 formed by a keyboard or mouse, an output section 112 formed by a display such as a CRT (Cathode Ray Tube) or LCD (Liquid Crystal Display), or a speaker or the like, the storage section 113 formed by a hard disk or the like, and a communication section 114 formed by a modem or the like. The communication section 114 performs a communication process via a network represented by the Internet, for example.

A drive 115 is also connected to the input/output interface 110 as required. A removable medium 121 such as a magnetic disk, an optical disk, a magneto-optical disk, or a semiconductor memory are mounted in the drive 115 as appropriate, and a computer program read from the removable medium 121 is installed into the storage section 113 as required.

Although not shown, a cache memory is provided within the CPU 101. Although this cache memory operates faster than the RAM 103, its capacity is smaller than that of the RAM 103. That is, the amount of data that can be stored into this cache memory at a time is limited. Accordingly, the CPU 101 stores into this cache memory data with a high usage frequency or data that will be used in the near future, and holds data with a low usage frequency, data that will not be used for the time being, or the like in the RAM 103.

As shown in FIG. 10, the personal computer 100 has only one arithmetic processing section, the CPU 101. Therefore, individual processes of a software encoder such as the encoding section 10 shown in FIG. 1 cannot be actually executed in parallel as shown in FIG. 9. Therefore, in order to make the individual processes be executed apparently in parallel, the CPU 101 must be time-shared and assigned to the individual processes. In this case, it may be possible to use a precinct as the unit of time-sharing.

That is, as shown in FIG. 1, supplied image data is subjected to a wavelet transform process with respect to one precinct, and reordering of coefficients and an entropy encoding process are applied. By repeating this series of processing a plurality of times for each precinct, one picture of image data is processed. This makes it possible to reduce the load or delay time due to a wavelet transform process as compared with a case where a wavelet transform is applied to the whole of the picture.

However, in a case where a wavelet transform process is simply applied with respect to the whole of one precinct, it is necessary to accumulate one precinct of input image data, resulting in an increase in required memory capacity. This may lead to not only an increase in circuit scale or cost but also an increase in load or delay time.

Accordingly, by directing attention to the fact that the wavelet transform section 11 performs a wavelet transform process by using a lifting operation as described above, a wavelet transform process is applied to one precinct of image data in an efficient manner to thereby reduce the accumulation amount of this image data.

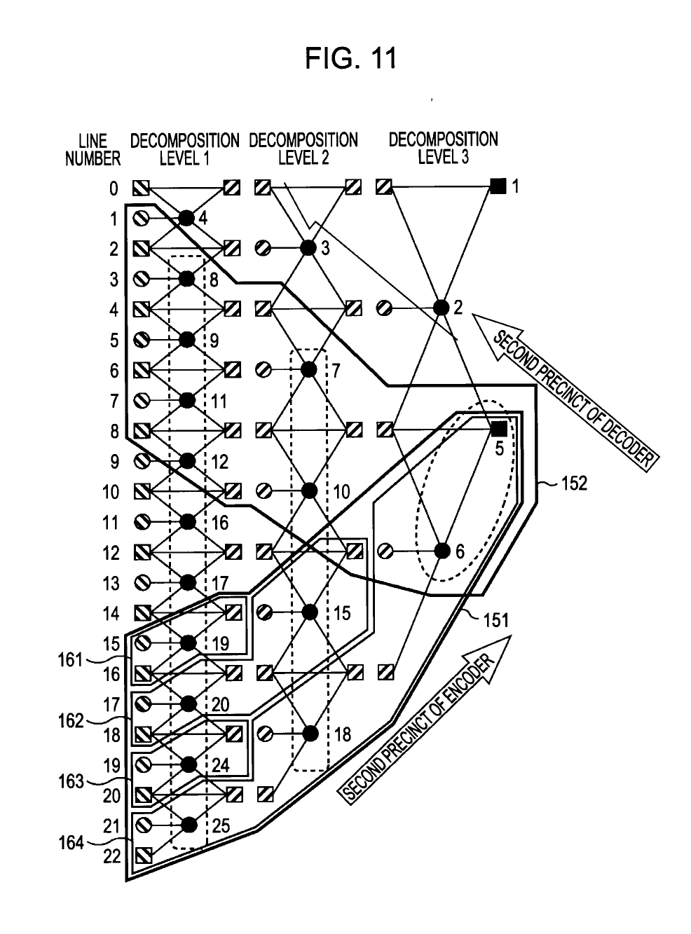

FIG. 11 shows the procedure of a lifting operation in the wavelet transform process. In FIG. 11, description will be directed to the second precinct that is the second precinct from the top of a picture. Basically, the same applies to the first precinct or precincts from the third precinct onwards.

FIG. 11 is basically the same diagram as FIG. 8, illustrating a lifting operation when a 5×3 filter is used for the analysis filtering process. Detailed description of FIG. 11 is thus omitted. It should be noted that numbers shown directly to the right of or below black circles () and black squares (▪) indicate the order in which respective pieces of coefficient data are subjected to a synthesis filtering process.

In FIG. 11, a portion enclosed by a curved line 151 indicates the second precinct (lifting operation with respect to the second precinct) in the encoding section 10. As described above with reference to FIG. 8, the lifting operation proceeds from the left to right in the drawing as indicated by a hollow arrow, that is, in such a way that lifting operations for generating higher frequency components are executed earlier. Thus, the lifting operation with respect to the second precinct can be performed in the manner as indicated by curved lines 161 to 164 every time two lines of image data are inputted. That is, when image data of line numbers 15 and 16 are inputted, the wavelet transform section 11 performs a lifting operation represented by the portion enclosed by the curved line 161, thus generating coefficient data that is subjected to a synthesis filtering process in the nineteenth turn. When image data of line numbers 17 and 18 are inputted, the wavelet transform section 11 performs a lifting operation represented by the portion enclosed by the curved line 162, thus generating coefficient data that is subjected to a synthesis filtering process in the twentieth turn and further generating coefficient data that is subjected to a synthesis filtering process in the fifteenth turn.

Subsequently, when image data of line numbers 19 and 20 are inputted, the wavelet transform section 11 performs a lifting operation represented by the portion enclosed by the curved line 163, thus generating coefficient data that is subjected to a synthesis filtering process in the twenty-fourth turn. When image data of line numbers 21 and 22 are inputted, the wavelet transform section 11 performs a lifting operation represented by the portion enclosed by the curved line 164, so the wavelet transform section 11 generates coefficient data that is subjected to a synthesis filtering process in the twenty-fifth turn, further generates coefficient data that is subjected to a synthesis filtering process in the eighteenth turn, and lastly generates coefficient data that is subjected to a synthesis filtering process in the sixth turn and coefficient data that is subjected to a synthesis filtering process in the fifth turn.

In this way, a lifting operation that can be executed every time two lines of image data are inputted is performed sequentially, which makes it unnecessary for the wavelet transform section 11 to accumulate one precinct of image data. This not only makes it possible to reduce the required memory capacity to achieve a reduction in circuit scale or manufacturing cost but also makes it possible to reduce the load or delay time due to a wavelet transform process.

It should be noted that a second precinct in the decoding section 20 corresponding to the second precinct in the encoding section 10 mentioned above is represented by the portion enclosed by a curved line 152 in FIG. 11. As indicated by the numbers added to coefficient data, the synthesis filtering process proceeds in the direction from the right to left in the drawing as indicated by a hollow arrow, that is, in such a way that, of the respective frequency components divided into individual frequency bands by the analysis filtering process, lower frequency components and, within the same frequency band, frequency components that are generated earlier, are processed earlier. In the encoding section 10, the processing order of entropy encoding is the same as the processing order of the inverse wavelet transform (synthesis filtering process) as described above. That is, this entropy encoding also proceeds in such a way that, of the respective frequency components decomposed into individual frequency bands by the analysis filtering process, lower frequency components and, within the same frequency band, frequency components that are generated earlier, are processed earlier.

Pieces of coefficient data outputted from the wavelet transform section 11, which are indicated by black circles or black squares, are supplied to the entropy encoding section 15 in the order of their numbers by the coefficient reordering section 14. The entropy encoding section 15 applies entropy encoding to the respective pieces of coefficient data in the order in which they are supplied, thereby obtaining encoded data of each coefficient data. That is, the entropy encoding section 15 cannot start entropy encoding with respect to coefficient data of the second precinct in the decoding section 20 until the coefficient data that is subjected to a synthesis filtering process in the fifth turn and the coefficient data that is subjected to a synthesis filtering process in the sixth turn, which are enclosed by a dotted ellipse in FIG. 11, are generated through the wavelet transform process.

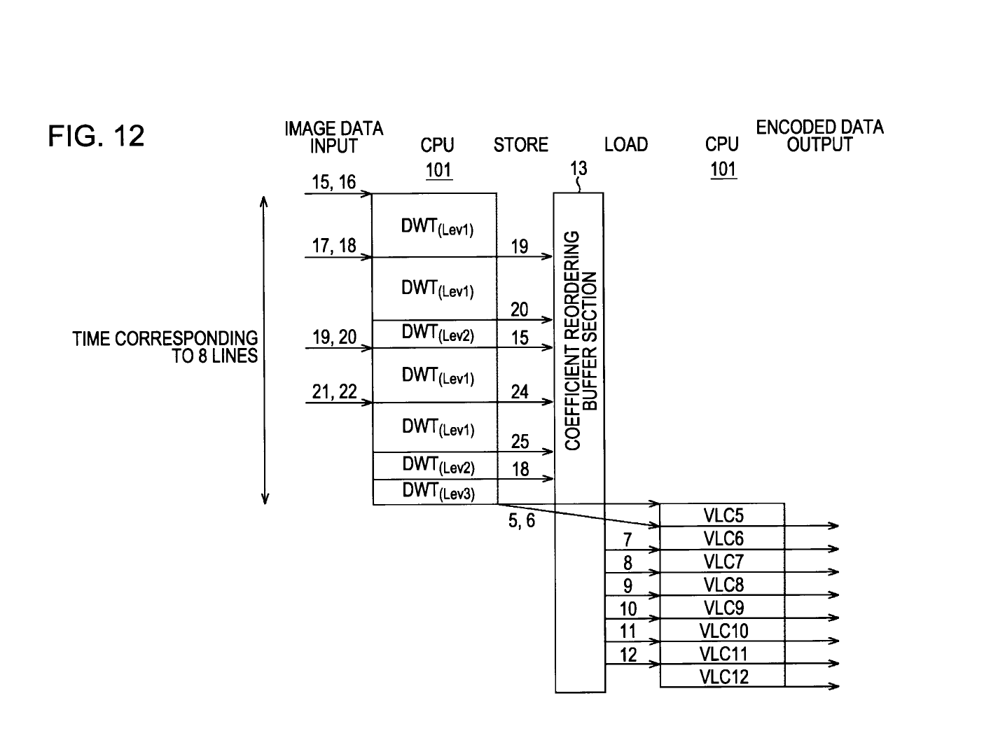

Accordingly, the CPU 101 causes respective processes of the encoding section 10 to proceed in the manner as shown in FIG. 12. In FIG. 12, the CPU 101 realizes the function of the encoding section 10 by executing a software program. It should be noted that image data to been encoded is inputted to the CPU 101 at normal playback speed, that is, in accordance with the synchronization timing of a video signal. That is, image data is supplied to the CPU 101 one line by one line, at a substantially constant interval in accordance with the horizontal synchronization timing of a video signal.

The CPU 101 performs a lifting operation (analysis filtering process) that can be executed every time two lines of image data are inputted, with respect to the second precinct in the encoding section 10 (DWT(Lev1) to DWT(Lev3)).

In FIG. 12, each square in which “DWT(Lev1)” is written represents an example of the time during which a synthesis filtering process at decomposition level 1 is assigned to the CPU 101, each square in which “DWT(Lev2)” is written represents an example of the time during which a synthesis filtering process at decomposition level 2 is assigned to the CPU 101, and a square in which “DWT(Lev3)” is written represents an example of the time during which a synthesis filtering process at decomposition level 3 is assigned to the CPU 101. That is, during the time represented by the square (DWT(Lev1)) at the top (period from the input of image data of line number 16 (and 15) to the input of image data of line number 18 (and 17)), the CPU 101 performs a lifting operation of the portion enclosed by the curved line 161 in FIG. 11. During the time represented by the second square (DWT(Lev1)) and the third square (DWT(Lev2)) from the top (period from the input of image data of line number 18 (and 17) to the input of image data of line number 20 (and 19)), the CPU 101 performs a lifting operation of the portion enclosed by the curved line 162 in FIG. 11. During the time represented by the fourth square (DWT(Lev1)) from the top (period from the input of image data of line number 20 (and 19) to the input of image data of line number 22 (and 21)), the CPU 101 performs a lifting operation of the portion enclosed by the curved line 163 in FIG. 11. During the time represented by the fifth square (DWT(Lev1)), the sixth square (DWT(Lev2)), and the seventh square (DWT(Lev3)) from the top (time after the input of image data of line number 22 (and 21)), the CPU 101 performs a lifting operation of the portion enclosed by the curved line 164 in FIG. 11.

In each lifting operation, when the CPU 101 generates coefficient data to been encoded, the CPU 101 causes the coefficient reordering buffer section 13 to sequentially hold the coefficient data. The coefficient reordering buffer section 13 is formed by, for example, a cache memory within the CPU 101 or the RAM 103.

Then, upon generating coefficient data that is subjected to a synthesis filtering process in the fifth turn and coefficient data that is subjected to a synthesis filtering process in the sixth turn, the CPU 101 starts entropy encoding with respect to coefficient data of the second precinct in the decoding section 20. It should be noted that since the last generated pieces of coefficient data at this time, that is, the coefficient data that is subjected to a synthesis filtering process in the fifth turn and the coefficient data that is subjected to a synthesis filtering process in the sixth turn, are small in data size and are to be used immediately, an entropy encoding process is started with these pieces of coefficient data held in the CPU 101 as they are, without being held in the coefficient reordering buffer section 13.

In this way, by taking advantage of the feature of coefficient reordering that the last generated coefficient data is encoded first, the holding of the coefficient data subjected to a synthesis filtering process in the fifth turn and coefficient data subjected to a synthesis filtering process in the sixth turn into the coefficient reordering buffer section 13 is omitted, thereby making it possible to reduce the memory capacity required of the coefficient reordering buffer section 13. This makes it possible not only to reduce the circuit scale and manufacturing cost but also to reduce the number of times data is written to and read from the coefficient reordering buffer section 13, thereby achieving a reduction in the load or delay time due to a wavelet transform process and encoding.

After starting entropy encoding, the CPU 101 encodes pieces of coefficient data that are subjected to a synthesis filtering process in the fifth to twelfth turns, in the order of their numbers one line by one line, and sequentially outputs the obtained pieces of encoded data.

In FIG. 12, the square in which “VLC5” is written illustrates the time during which an entropy encoding process of encoding coefficient data that is subjected to a synthesis filtering process in the fifth turn is assigned to the CPU 101. Likewise, “VLC6” to “VLC12” illustrate the times during which entropy encoding processes of encoding pieces of coefficient data that are subjected to a synthesis filtering process in the sixth to twelfth turns are assigned to the CPU 101.

While FIG. 12 shows the flow of time from top to bottom in the vertical direction in the drawing, the length (scale) in the vertical direction does not accurately represent the length of time. For example, although it appears in FIG. 12 as if image data were inputted two lines at a time, and the interval of input were not constant, in actuality, image data is inputted one line at a time in a substantially constant cycle in accordance with the horizontal synchronization timing of a video signal.

As described above, each of the squares (excluding the coefficient reordering buffer section 13) shown in FIG. 12 represents the time during which a process such as a lifting operation or entropy encoding is assigned to the CPU 101. While this indicates that the CPU 101 performs an assigned process during the time represented by the square, this does not indicate the processing time of each process by the CPU 101. That is, there are cases where the CPU 101 finishes a process within a part of the time represented by a square. Also, as described above, the length in the vertical direction in FIG. 12 does not accurately represent the length of time, nor does the length of a square in the vertical direction accurately represent the assigned time for a process.

In the case of the process flow as shown in FIG. 12, although the CPU 101 can perform an analysis filtering process in real time (instantaneously) with respect to image data inputted during the period in which a wavelet transform process (DWT) is performed, the CPU 101 cannot perform an analysis filtering process in real time (instantaneously) with respect to image data inputted during the period in which an entropy encoding process (VLC) is performed.

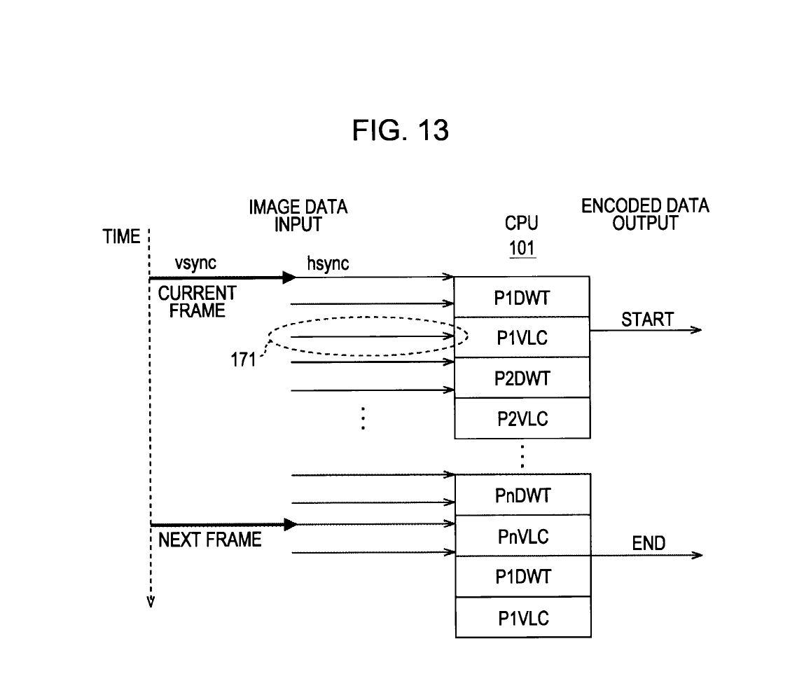

That is, as shown in FIG. 13, like a video signal at a normal playback speed, image data inputted at a predetermined speed is inputted on a picture by picture basis in synchronization with the synchronization timing of the vertical synchronizing signal (vsync) of the video signal. Image data of each picture is inputted on a line by line basis in synchronization with the synchronization timing of the horizontal synchronizing signal (hsync) of the video signal. That is, image data is inputted per one line substantially regularly (at a substantially constant pace). In contrast, as shown in FIG. 13, the CPU 101 alternately executes a wavelet transform process (DWT) and an entropy encoding process (VLC) on a precinct by precinct basis.

Therefore, for example, the CPU 101 cannot perform a wavelet transform process (DWT) in real time (instantaneously) with respect to image data that is input in accordance with a horizontal synchronization timing generated while the CPU 101 is encoding (P1VLC) coefficient data of the first precinct, as indicated by an arrow enclosed by a dotted ellipse 171 in FIG. 13 (because encoding (VLC) is being performed). Accordingly, that image data must be buffered (held) until the CPU 101 starts a wavelet transform process (P2DWT) with respect to the next second precinct.

Provided that the encoding process of one precinct can be all finished between horizontal synchronization timings, the CPU 101 is not required to buffer image data and thus can perform a wavelet transform process in real time. However, employing such a method is not practical because the method places an extremely large load on the CPU 101, and to realize this method, it is necessary to make the operating frequency of the CPU 101 extremely high, which may lead to an increase in cost. In order to process image data at the processing speed of a CPU that is available at practical cost, buffering of input image data as described above becomes necessary.

It should be noted that FIG. 13 is a schematic representation of the relationship between image data inputs and processes executed at the CPU 101, and the arrows indicative of a horizontal synchronizing signal (hsync) shown in FIG. 13 are a schematic representation of representative horizontal synchronization timings used for the purpose of explanation, and do not accurately represent all the horizontal synchronization timings. Further, as in FIG. 12, FIG. 13 shows the flow of time from top to bottom in the vertical direction in the drawing, but the length in the vertical direction of the drawing does not accurately represent the length of time.

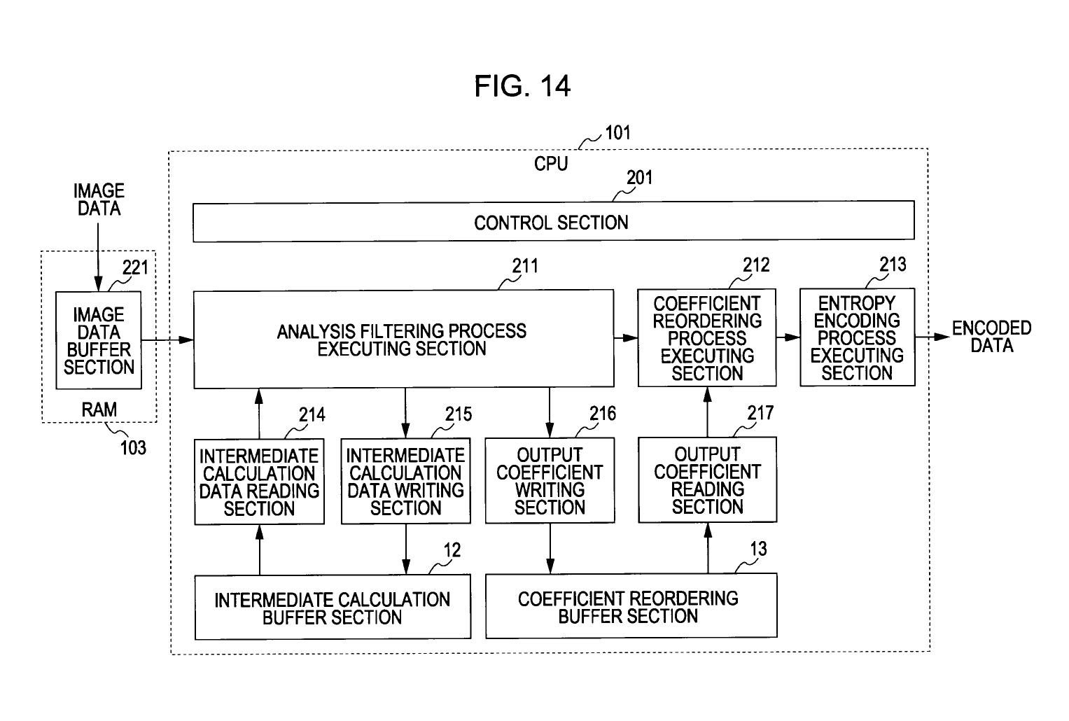

Next, a more specific description will be given of how the encoding section 10 that executes processes in accordance with the above-mentioned flow is realized. FIG. 14 is a functional block diagram showing functions included in the CPU 101 that executes a software program for realizing the encoding section 10 that executes processes in accordance with the above-mentioned flow.

In FIG. 14, the CPU 101 has a control section 201, an analysis filtering process executing section 211, a coefficient reordering process executing section 212, an entropy encoding process executing section 213, an intermediate calculation data reading section 214, an intermediate calculation data writing section 215, an output coefficient writing section 216, and an output coefficient reading section 217.

The control section 201 controls the flow of respective processes of the encoding section 10 by controlling the operations of respective sections from the analysis filtering process executing section 211 to the output coefficient reading section 217. Further, the control section 201 also controls the input/output of data to/from an image data buffer section 221 described later.

The analysis filtering process executing section 211 is controlled by the control section 201 to execute an analysis filtering process for realizing the function of the wavelet transform section 11 shown in FIG. 1 which performs an analysis filtering process (lifting operation) on inputted image data. When executing the analysis filtering process, the analysis filtering process executing section 211 acquires intermediate calculation data (image data or coefficient data) required for the next lifting operation, from the intermediate calculation buffer section 12 via the intermediate calculation data reading section 214. Further, the analysis filtering process executing section 211 supplies intermediate calculation data obtained by a lifting operation, to the intermediate calculation buffer section 12 via the intermediate calculation data writing section 215 to be held therein. Further, the analysis filtering process executing section 211 supplies pieces of coefficient data which are obtained by a lifting operation and on which no further analysis filtering process is to be performed (low-frequency components and high-frequency components in the highest decomposition level, and high-frequency components at decomposition levels other than the highest decomposition level) as output coefficients, to the coefficient reordering buffer section 13 via the output coefficient writing section 216 to be held therein.

The coefficient reordering process executing section 212 is controlled by the control section 201 to execute a coefficient reordering process for realizing the function of the coefficient reordering section 14 shown in FIG. 1, which reads output coefficients held in the coefficient reordering buffer section 13 and supplies the output coefficients to the entropy encoding section 15. The coefficient reordering process executing section 212 acquires output coefficients held in the coefficient reordering buffer section 13 in the order in which they are encoded (in the order in which they are subjected to a synthesis filtering process) via the output coefficient reading section 217, and supplies the acquired output coefficients to the entropy encoding process executing section 213, thereby reordering the coefficients.

The entropy encoding process executing section 213 is controlled by the control section 201 to execute an entropy encoding process for realizing the function of the entropy encoding section 15 shown in FIG. 1 which encodes pieces of coefficient data supplied from the coefficient reordering section 14 in the order in which they are supplied. The entropy encoding process executing section 213 encodes pieces of coefficient data (output coefficients) supplied from the coefficient reordering process executing section 212 in the order in which they are supplied, and outputs the obtained encoded data to the external of the CPU 101, such as the RAM 103, the output section 112, the storage section 113, the communication section 114, or the removable medium 121.

The intermediate calculation data reading section 214 and the intermediate calculation data writing section 215 are controlled by the control section 201 to read or write intermediate calculation data to or from a cache memory (not shown), the RAM 103, or the like, thereby forming the intermediate calculation buffer section 12 shown in FIG. 1 in the storage area of the cache memory (not shown), the RAM 103, or the like. The intermediate calculation data reading section 214 reads necessary data from a set of intermediate calculation data held in the intermediate calculation buffer section 12 and supplies the data to the analysis filtering process executing section 211. The intermediate calculation data writing section 215 writes (holds) intermediate calculation data supplied from the analysis filtering process executing section 211 into the intermediate calculation buffer section 12.

The output coefficient writing section 216 and the output coefficient reading section 217 are controlled by the control section 201 to read or write output coefficients to or from a cache memory (not shown), the RAM 103, or the like, thereby forming the coefficient reordering buffer section 13 shown in FIG. 1 in the storage area of the cache memory (not shown), the RAM 103, or the like. The output efficient writing section 216 writes (holds) output coefficients supplied from the analysis filtering process executing section 211 into the coefficient reordering buffer section 13. The output coefficient reading section 217 reads output coefficients held in the coefficient reordering buffer section 13 in the order specified by the coefficient reordering process executing section 212 and supplies the read output coefficients to the coefficient reordering process executing section 212.

An image data buffer section 221 is a buffer section that temporarily holds inputted image data, and is formed in, for example, the RAM 103 by control of the control section 201. The image data buffer section 221 is controlled by the control section 201 to temporarily hold image data that is supplied substantially regularly one line by one line, and supplies the held image data one line by one line to the analysis filtering process executing section 211 in accordance with a predetermined timing.

While FIG. 14 shows a case in which the intermediate calculation buffer section 12 and the coefficient reordering buffer section 13 are formed in a cache memory (not shown) within the CPU 101, and the image data buffer section 22 is formed in the RAM 103, this is merely an example. The intermediate calculation buffer section 12, the coefficient reordering buffer section 13, and the image data buffer section 221 can each be formed in an arbitrary storage area. It should be noted, however, that as described above, although a cache memory allows fast access, its capacity is smaller than that of the RAM 103. Thus, in order to prevent a buffer overflow or the like which may cause an unwanted increase in load or delay time, desirably, only data that is frequently read and written, or only data that is intended to used in the near future is stored into the cache memory. For example, the intermediate calculation buffer section 12 that is frequently accessed may be formed in the cache memory, and the image data buffer section 221 or the coefficient reordering buffer section 13 that is not frequently accessed may be formed in the RAM 103.

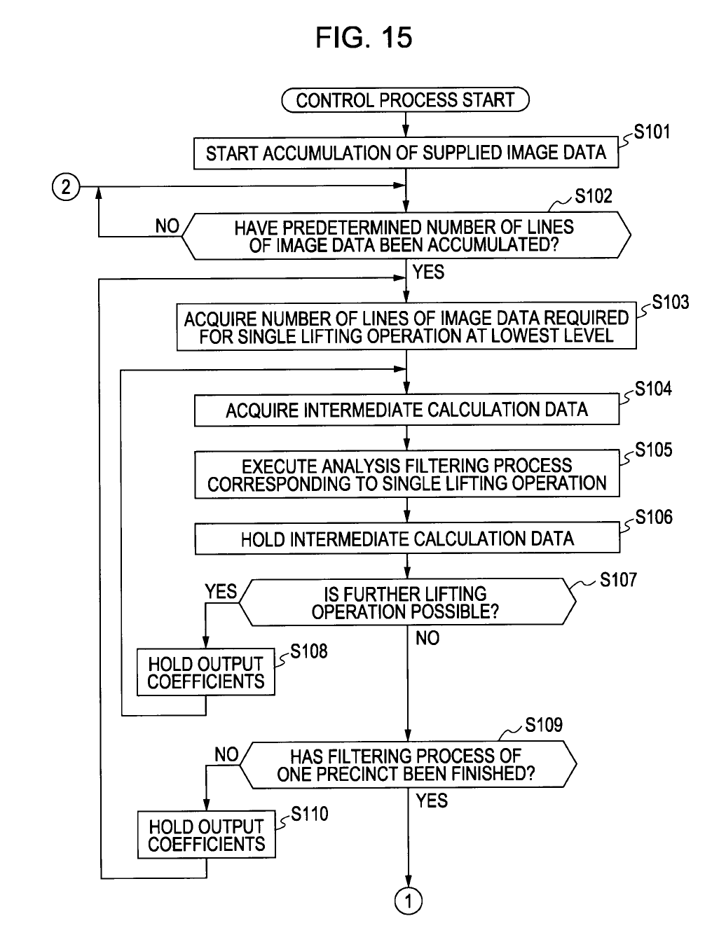

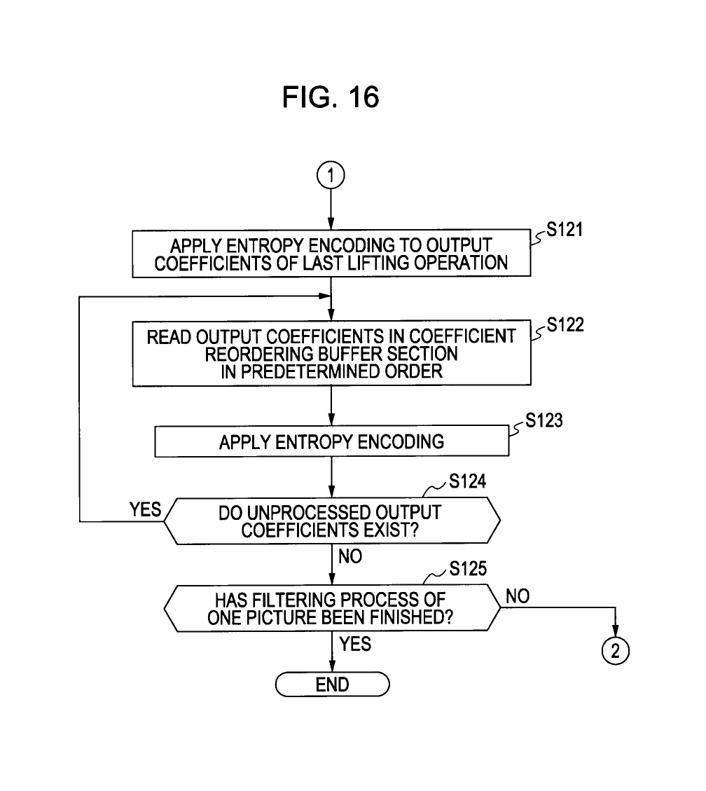

The control section 201 shown in FIG. 14 executes a control process of controlling respective sections to realize the encoding section 10 shown in FIG. 1. An example of the flow of the control process will be described with reference to the flowcharts of FIGS. 15 and 16.

When the control process is started, in step S101, the control section 201 causes the image data buffer section 221 to be formed in, for example, the RAM 103, and causes the image data buffer section 221 to start accumulation of supplied image data. Thereafter, the image data buffer section 221 controlled in this way temporarily holds image data that is supplied one line by one line, until the control process is finished.

In step S102, the control section 201 determines whether or not predetermined lines of image data have been accumulated in the image data buffer section 221, and waits on standby until it is determined that the predetermined lines of image data have been accumulated. If it is determined that a sufficient amount of image data for performing a lifting operation in the analysis filtering process executing section 211 have been accumulated, the control section 201 advances the process to step S103.

In step S103, the control section 201 controls the analysis filtering process executing section 211 to acquire the number of lines (for example, two lines or three lines) of image data necessary for performing a single lifting operation in the lowest level, that is, for performing a single lifting operation of the analysis filtering process at decomposition level 1, from the image data buffer section 221. Through this control, the analysis filtering process executing section 211 acquires the number of lines of image data necessary for performing a single lifting operation in the lowest level, in the order of line numbers from the image data buffer section 221.

In step S104, the control section 201 controls the analysis filtering process executing section 211 to acquire, from the intermediate calculation buffer section 12, intermediate calculation data necessary for the lifting operation that is going to be performed next. Through this control, the analysis filtering process executing section 211 controls the intermediate calculation data reading section 214 to read, from the intermediate calculation buffer section 12, intermediate calculation data necessary for the lifting operation that is going to be performed next, and to supply the intermediate calculation data to the analysis filtering process executing section 211 (that is, the analysis filtering process executing section 211 acquires intermediate calculation data). Through this control, the intermediate calculation data reading section 214 reads the requested intermediate calculation data from the intermediate calculation buffer section 12, and supplies the read data to the analysis filtering process executing section 211.

In step S105, the control section 201 controls the analysis filtering process executing section 211 to execute a single lifting operation of an analysis filtering process. Through this control, as described above with reference to FIG. 11, the analysis filtering process executing section 211 executes a single lifting operation (operation of the portion enclosed by a curved line) of an analysis filtering process that can be executed.

When the lifting operation is performed, in step S106, the control section 201 controls the analysis filtering process executing section 211 to hold, from among image data and coefficient data used in the lifting operation and coefficient data obtained by the lifting operation, those pieces of data which are to be used for the subsequent lifting operations, in the intermediate calculation buffer section 12 as intermediate calculation data. Through this control, the analysis filtering process executing section 211 supplies intermediate calculation data to the intermediate calculation data writing section 215, and also controls the intermediate calculation data writing section 215 to write the supplied intermediate calculation data into the intermediate calculation buffer section 12. Through this control, the intermediate calculation data writing section 215 writes the intermediate calculation data supplied from the analysis filtering process executing section 211 into the intermediate calculation buffer section 12 to be held therein.

In step S107, the control section 201 determines whether or not a lifting operation is possible without input of additional image data. If it is determined that a lifting operation is possible, the control section 201 advances the process to step S108, where the control section 201 controls the analysis filtering process executing section 211 to hold output coefficients obtained by the lifting operation into the coefficient reordering buffer section 13. Through this control, the analysis filtering process executing section 211 supplies output coefficients to the output coefficient writing section 216, and controls the output coefficient writing section 216 to write the supplied output coefficients into the coefficient reordering buffer section 13. Through this control, the output coefficient writing section 216 writes the output coefficients supplied from the analysis filtering process executing section 211 into the coefficient reordering buffer section 13 to be held therein.

When the process of step S108 is finished, the control section 201 returns the process to step S104, and repeats the subsequent processes. That is, as described above with reference to FIG. 11, the control section 201 repeats the processes of step S104 to step S108 to perform all the lifting operations that can be executed in correspondence to inputted image data.

Then, if it is determined in step S107 that there are no more lifting operations that can be executed, the control section 201 advances the process to step S109.

In step S109, the control section 201 determines whether or not a filtering process of one precinct has been finished. If it is determined that a filtering process of one precinct has not been finished, the control section 201 advances the process to step S110, and as in step S108, the control section 201 controls the analysis filtering process executing section 211 to hold output coefficients obtained by a lifting operation into the coefficient reordering buffer section 13. When the process of step S110 is finished, the control section 201 returns the process to step S103, and repeats the subsequent processes. That is, as described above with reference to FIG. 11, the control section 201 repeats the processes of step S103 to step S110 to execute a lifting operation of one precinct.

Then, if it is determined in step S109 that a filtering process of one precinct has been finished, the control section 201 advances the process to step S121 in FIG. 16. In step S121 in FIG. 16, the control section 201 controls the entropy encoding process executing section 213 to apply entropy encoding to output coefficients of the last lifting operation. The “output coefficients of the last lifting operation” correspond to the coefficient data that is subjected to a synthesis filtering process in the fifth turn and the coefficient data that is subjected to a synthesis filtering process in the sixth turn in FIG. 11 described above. That is, the output coefficients of the last lifting operation are entropy encoded without the intermediation of the coefficient reordering buffer section 13. By the control section 201 performing the control mentioned above, it is possible to achieve a reduction in the memory capacity required of the coefficient reordering buffer section 13, and also a reduction in load or delay time.

Through the control of step S121, the entropy encoding process executing section 213 encodes the coefficient data that is subjected to a synthesis filtering process in the fifth turn and the coefficient data that is subjected to a synthesis filtering process in the sixth turn in order, and sequentially outputs the obtained encoded data.

When the above encoding process is finished, in step S122, the control section 201 controls the coefficient reordering process executing section 212 to read output coefficients in the coefficient reordering buffer section 13 in a predetermined order. Through this control, the coefficient reordering process executing section 212 controls the output coefficient reading section 217 to read pieces of coefficient data held in the coefficient reordering buffer section 13 in the order in which they are subjected to a synthesis filtering process, and to supply the read pieces of coefficient data to the coefficient reordering process executing section 212. Through this control, the output coefficient reading section 217 reads pieces of coefficient data held in the coefficient reordering buffer section 13 in the order in which they are subjected to a synthesis filtering process, and supplies the read pieces of coefficient data to the coefficient reordering process executing section 212. The coefficient reordering process executing section 212 sequentially supplies the supplied pieces of coefficient data to the entropy encoding process executing section 213.

In step S123, the control section 201 controls the entropy encoding process executing section 213 to apply entropy encoding to the coefficient data read from the coefficient reordering buffer section 13. Through this control, the entropy encoding process executing section 213 encodes the read coefficient data, and outputs the obtained encoded data.

In step S124, the control section 201 determines whether or not output coefficients that have not been encoded exist in the coefficient reordering buffer section 13. If it is determined that such output coefficients exist, the control section 201 returns the process to step S122, and repeats the subsequent processes. That is, by repeating the processes from step S122 to step S124, the control section 201 executes an encoding process with respect to all the output coefficients held in the coefficient reordering buffer section 13. At the point in time when the process of step S121 is started, output coefficients corresponding to one precinct (excluding the output coefficients of the last lifting operation) are accumulated in the coefficient reordering buffer section 13. The control section 201 executes an encoding process with respect to all of these output coefficients.

If it is determined in step S124 that unprocessed output coefficients do not exist in the coefficient reordering buffer section 13, the control section 201 advances the processing to step S125.

In step S125, the control section 201 determines whether or not an analysis filtering process of one picture has been finished. That is, the control section 201 determines whether or not an analysis filtering process (and an entropy encoding process) has been performed with respect to all of the precincts within the picture. If it is determined that unprocessed precincts exist, the control section returns the process to step S102 in FIG. 15, and repeats the subsequent processes. That is, by repeatedly executing the respective processes from step S102 to step S125, the control section 201 performs the above-described control process with respect to all of the precincts.

If it is determined in step S125 that an analysis filtering process of one picture has been finished, the control section 201 terminates the control process. It should be noted that this control process is repeatedly executed for each picture of image data.

By performing a control process as described above, the control section 201 performs an analysis filtering process efficiently, thereby reducing the memory capacity required of the image data buffer section 221. Further, since the control section 201 does not cause the output coefficients of the last lifting operation to be accumulated in the coefficient reordering buffer section 13, it is possible to achieve a reduction in the memory capacity required of the coefficient reordering buffer section 13 and also a reduction in load or delay time.

While FIGS. 15 and 16 are directed to a flow of control process, as described above, the respective sections from the analysis filtering process executing section 211 to the output coefficient reading section 217 execute processes corresponding to the control of the control section 201 in correspondence to the respective steps of this control process. Therefore, since the respective steps of the control process shown in the flowcharts of FIGS. 15 and 16 are regarded as also representing processes executed by the respective sections from the analysis filtering process executing section 211 to the output coefficient reading section 217, illustration of the processes executed by these respective sections is omitted.

Next, another way of advancing processes will be described.

As described above with reference to FIG. 11, the encoding process with respect to the second precinct in the decoding section 20 cannot be started until the wavelet transform process with respect to the second precinct in the encoding section 10 is finished. Thus, as described above with reference to FIG. 12, the CPU 101 alternately executes a wavelet transform process and an entropy encoding process on a precinct by precinct basis. However, if, for example, the CPU 101 can execute each analysis filtering process at higher speed to finish the analysis filtering process in a shorter time than the interval between image data input timings (horizontal synchronization timings), a waiting time occurs until the next horizontal synchronization timing (analysis filtering process start timing), resulting in a decrease in the usage efficiency of the CPU 101.

For example, in the case of FIG. 2 as well, an analysis filtering process is performed three times after image data of line number 21 (and line number 20) is inputted, whereas an analysis filtering process is performed only once when image data of line number 16 (and line number 15) is inputted. That is, a waiting time occurs until image data of the next line number 18 (and line number 17) is inputted. Such a waiting time causes a decrease in the usage efficiency of the CPU 101, and the lower efficiency translates into a greater load on the CPU 101 during execution of a process. Therefore, a high-performance CPU must be used, which also leads to an increase in manufacturing cost or power consumption. That is, to reduce the load placed on the CPU 101, it is required to improve the usage efficiency of the CPU 101 (make the CPU 101 operate with greater efficiency).

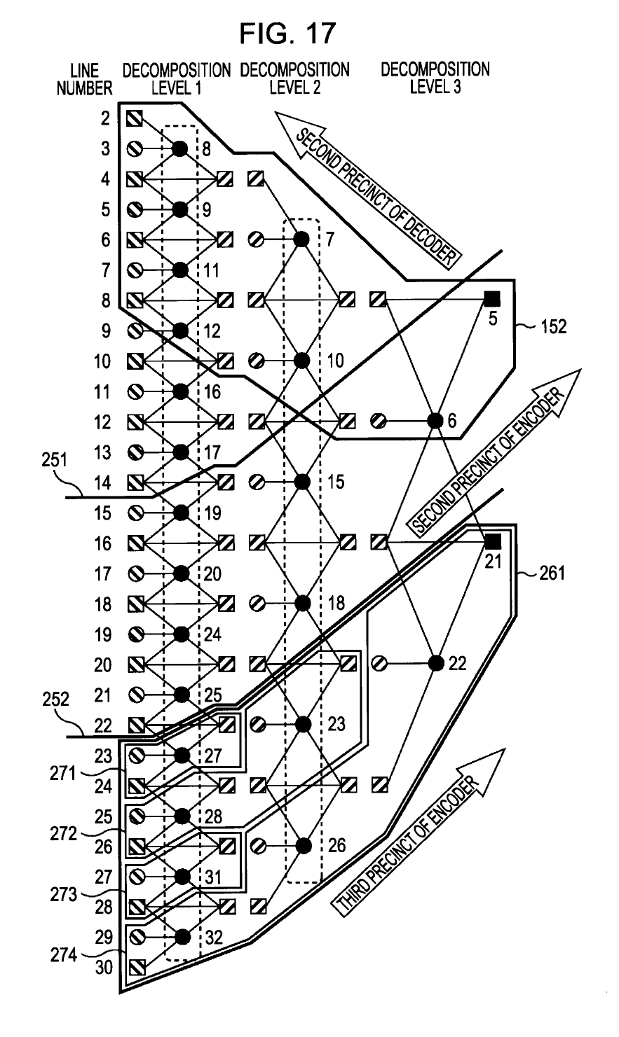

Accordingly, in order to suppress occurrence of such a waiting time and improve the usage efficiency of the CPU 101, as shown in FIG. 17, a precinct to which an entropy encoding process is applied is delayed by one cycle with respect to a precinct to which a wavelet transform process is applied. In other words, an encoding process is performed in such a way that encoding is always applied to frequency components that are generated earlier than the lowest frequency components generated last by the lifting operation. In still other words, the progress of a wavelet transform process with respect to the progress of an encoding process is advanced relative to that in the case described above with reference to FIG. 11, so that before the encoding process encodes the lowest frequency components, the wavelet transform process generates the lowest frequency components, and the encoding process encodes the next frequency components at all times.

In the example shown in FIG. 17, an encoding process is applied to the second precinct in the decoding section 20 while applying a wavelet transform process to the third precinct in the encoding section 10. Of course, the same applies to other precincts as well, so description thereof is omitted.

Since FIG. 17 corresponds to FIG. 11, its detailed description is omitted. In FIG. 17, a curved line 251 indicates the boundary between the first precinct (line number 10 to line number 14) and the second precinct (line number 15 to line number 22) in the encoding section 10, and a curved line 252 indicates the boundary between the second precinct (line number 15 to line number 22) and the third precinct (line number 23 to line number 30) in the encoding section 10.

As shown in FIG. 17, output coefficients generated by a wavelet transform process applied to the third precinct in the encoding section 10 (black circles () and black squares (▪) in the portion enclosed by the curved line 261), and output coefficients that are processed during entropy encoding applied to the second precinct in the decoding section 20 (black circles () and black squares (▪) in the portion enclosed by the curved line 152) do not overlap each other. Therefore, the wavelet transform process with respect to the third precinct in the encoding section 10, and the entropy encoding with respect to the second precinct in the decoding section 20 can be performed in a simultaneous parallel manner. It should be noted that since the CPU 101 is a single arithmetic processing section, the expression “in a simultaneous parallel manner” as used herein does not mean that two processes are actually performed simultaneously in parallel but that the times from the start to the end of two processes overlap each other. More specifically, the CPU 101 is time-shared, and the wavelet transform process and the entropy encoding process are alternately executed in finer processing units. This makes the time from the start to the end of the wavelet transform process and the time from the start to the end of the entropy encoding process to overlap each other, thus allowing the CPU 101 to execute two processes apparently “in a simultaneous parallel manner”.

That is, in the example shown in FIG. 17, the CPU 101 performs the following lifting operations as the wavelet transform process with respect to the third precinct in the encoding section 10. That is, when image data of line number 23 and image data of line number 24 are inputted, the CPU 101 performs a lifting operation enclosed by a curved line 271. When image data of line number 25 and image data of line number 26 are inputted, the CPU 101 performs a lifting operation enclosed by a curved line 272. When image data of line number 27 and image data of line number 28 are inputted, the CPU 101 performs a lifting operation enclosed by a curved line 273. When image data of line number 29 and image data of line number 30 are inputted, the CPU 101 performs a lifting operation enclosed by a curved line 274. During a waiting time that occurs between these processes, the entropy encoding process with respect to the second precinct in the decoding section 20, as represented by the portion enclosed by the curved line 152, is executed by the CPU 101 for as many lines that can be processed as possible.

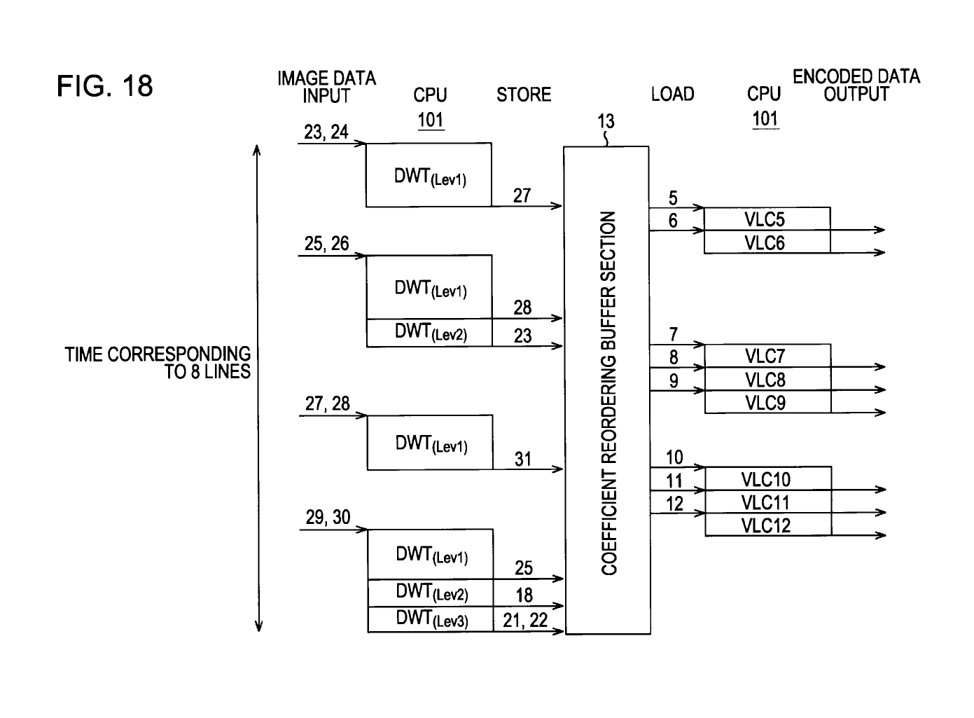

FIG. 18 schematically shows the flow of processes executed in the CPU 101 in this case. FIG. 18 corresponds to FIG. 12 and shows basically the same configuration as that of FIG. 12, so its detailed description is omitted.

In FIG. 18 as well, as in the case of FIG. 12, the CPU 101 performs a lifting operation (analysis filtering process) that can be executed every time two lines of image data are inputted, with respect to the third precinct in the encoding section 10 (DWT(Lev1) to DWT(Lev3)). However, in the case of FIG. 18, during the period of time after the end of a lifting operation until the input of the next two lines of data (until the timing of starting the execution of the next lifting operation), the CPU 101 executes an entropy encoding process with respect to the second precinct in the decoding section 20, per line of coefficient data.

That is, in FIG. 18, when image data of line number 24 (and 23) is inputted, the CPU 101 performs lifting operation DWT(Lev1) of the portion enclosed by the curved line 271 in FIG. 17 to generate coefficient data that is subjected to a synthesis filtering process in the twenty-seventh turn, and holds the coefficient data in the coefficient reordering buffer section 13. Thereafter, by making use of the time left until the timing of starting the execution of the next lifting operation, the CPU 101 sequentially applies entropy encoding to the pieces of coefficient data that are subjected to a synthesis filtering process in the fifth and sixth turns (VLC5 and VLC6), and sequentially outputs the encoded data obtained through the respective processes.

Then, when image data of line number 26 (and 25) is inputted, the CPU 101 performs lifting operations DWT(Lev1) and DWT(Lev2) of the portion enclosed by the curved line 272 in FIG. 17 to generate coefficient data that is subjected to a synthesis filtering process in the twenty-eighth turn and coefficient data that is subjected to a synthesis filtering process in the twenty-third turn, respectively, and holds those pieces of coefficient data in the coefficient reordering buffer section 13. Thereafter, by making use of the time left until the timing of starting the execution of the next lifting operation, the CPU 101 sequentially applies entropy encoding to the pieces of coefficient data that are subjected to a synthesis filtering process in the seventh to ninth turns (VLC7, VLC8, and VLC9), and sequentially outputs the encoded data obtained through the respective processes.

Next, when image data of line number 28 (and 27) is inputted, the CPU 101 performs lifting operation DWT(Lev1) of the portion enclosed by the curved line 273 in FIG. 17 to generate coefficient data that is subjected to a synthesis filtering process in the thirty-first turn, and holds the coefficient data in the coefficient reordering buffer section 13. Thereafter, by making use of the time left until the timing of starting the execution of the next lifting operation, the CPU 101 sequentially applies entropy encoding to the pieces of coefficient data that are subjected to a synthesis filtering process in the tenth to twelfth turns (VLC10, VLC11, and VLC12), and sequentially outputs the encoded data obtained through the respective processes.

Then, when image data of line number 30 (and 29) is inputted, the CPU 101 performs lifting operations DWT(Lev1), DWT(Lev2), and DWT(Lev3) of the portion enclosed by the curved line 274 in FIG. 17 to generate coefficient data that is subjected to a synthesis filtering process in the twenty-fifth turn, coefficient data that is subjected to a synthesis filtering process in the eighteenth turn, coefficient data that is subjected to a synthesis filtering process in the twenty-first turn, and coefficient data that is subjected to a synthesis filtering process in the twenty-second turn, respectively, and sequentially holds those pieces of coefficient data in the coefficient reordering buffer section 13.

In this way, a precinct to which an entropy encoding process is to be applied is delayed by one cycle with respect to a precinct to which a wavelet transform process is to be applied. That is, the encoding process always applies encoding to frequency components generated earlier than frequency components of the lowest frequency band generated last by a lifting operation. The CPU 101 can thus execute an entropy encoding process by making use of the free time produced during a wavelet transform process, thus allowing the wavelet transform process and the entropy encoding process to be executed apparently in a simultaneous parallel manner. This makes it possible to reduce the waiting time of the CPU 101, thereby achieving improved usage efficiency of the CPU 101.

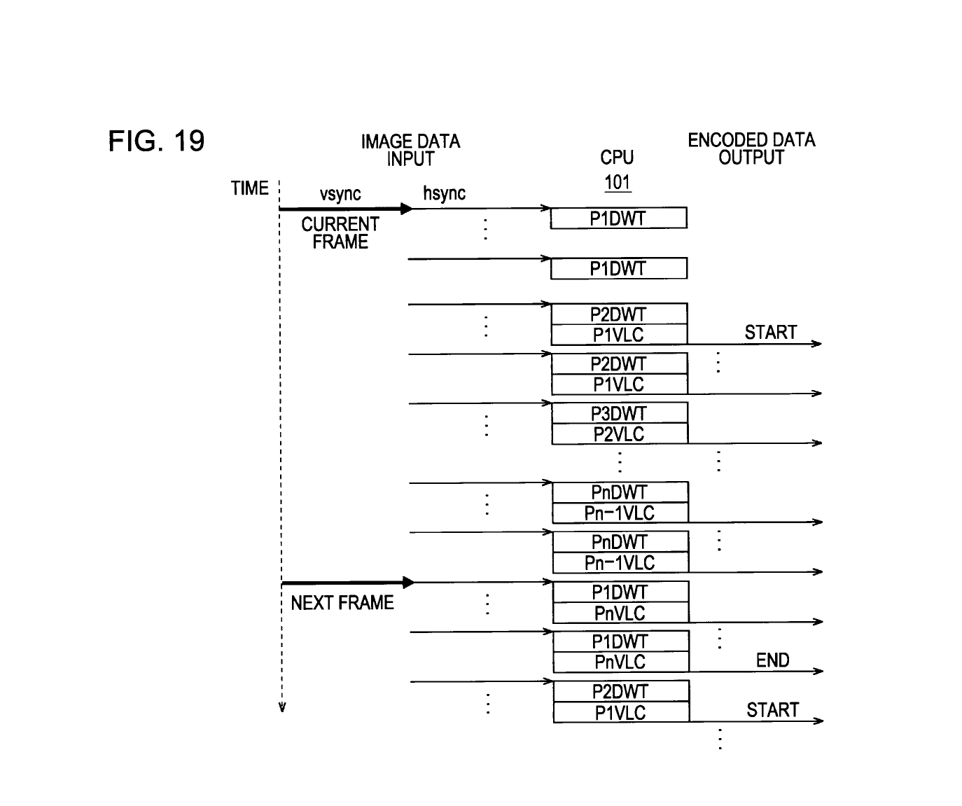

Further, The CPU 101 can thus easily perform an analysis filtering process in real time (instantaneously). As shown in FIG. 19, in accordance with the input timing (hsync) of two lines of image data, the CPU 101 executes a wavelet transform process with respect to one precinct in a plurality of times (P1DWT, P2DWT, P3DWT, . . . , PnDWT). During the free times in these wavelet transform processes, the CPU 101 performs all of the encoding processes with respect to respective output coefficients (P1VLC, P2VLC, Pn-P1VLC, PnVLC). In this way, by performing an entropy encoding process during the free time in a wavelet transform process, with a process to each output coefficient as the processing unit, even the CPU 101 that does not have high performance can easy perform a wavelet transform in real time (instantaneously).

Therefore, in this case, there is no need to buffer inputted image data, thus making the image data buffer section 221 unnecessary. Therefore, as compared with the method described above with reference to FIGS. 12 to 16, not only is it possible to reduce the memory capacity required for processes performed by the encoding section 10, but also it is possible to omit the time for buffering image data, thereby achieving a reduction in load of delay time due to the wavelet transform process and the entropy encoding process.

A comparison between FIG. 12 and FIG. 18 shows that in the case of FIG. 18, the output timing of encoded data obtained by encoding coefficient data that is subjected to a synthesis filtering process in the fifth turn is delayed by a time corresponding to the lifting operation DWT(Lev1) performed after image data of line number 24 (and 23) is inputted, and also, the amount of data accumulated in the coefficient reordering buffer section 13 is larger by an amount corresponding to the pieces of coefficient data that are subjected to a synthesis filtering process in the fifth, sixth, and twenty-seventh turns. However, the lifting operation DWT(Lev1) is equal to a delay time corresponding to a single lifting operation at decomposition level 1, and is shorter than the interval between the input timings of two lines of image data as shown in FIG. 18. Further, the coefficient data that is subjected to a synthesis filtering process in the fifth turn and accumulated in the coefficient reordering buffer section 13 corresponds to one line of low-frequency component at decomposition level 3, the coefficient data that is subjected to a synthesis filtering process in the sixth turn corresponds to one line of high-frequency component at decomposition level 3, and the coefficient data that is subjected to a synthesis filtering process in the twenty-seventh turn corresponds to one line of high-frequency component at decomposition level 1. The data amount of each of those pieces of data is thus less than that of one line of image data (see FIG. 4).

In the method shown in FIG. 12, in a case where a wavelet transform process cannot be performed in real time due to entropy encoding, the processing time required for an entropy encoding process of one precinct is longer than the interval between the input timings (hsync) of two lines of image data. The amount of image data accumulated in the image data buffer section 221 at that time is larger than that of two lines of image data.

Therefore, if a comparison is made by also taking into account this amount of input image data to be buffered, the method shown in FIG. 18 requires less memory capacity and results in a shorter delay time than the method shown in FIG. 12. Since the usage frequency of the CPU 101 is higher than that in the method shown in FIG. 12, image data inputted at a predetermined speed can be processed in real time with less load.

It should be noted that while FIG. 18 shows a case in which pieces of coefficient data that are subjected to a synthesis filtering process in the fifth and sixth turns are accumulated in the coefficient reordering buffer section 13, as in the case of FIG. 12, these pieces of coefficient data may be subjected to an entropy encoding process without being accumulated in the coefficient reordering buffer section 13. In this case, the CPU 101 can start the entropy encoding process with respect to the second precinct in the decoding section 20, before starting the wavelet transform with respect to the third precinct after the last lifting operation in the second precinct in the encoding section 10 is finished. This allows the CPU 101 to make the encoded data obtained by encoding coefficient data that is subjected to a synthesis filtering process in the fifth turn be outputted at an earlier timing, and it is also possible to achieve a further reduction in the memory capacity required of the coefficient reordering buffer section 13.

Further, in the case of FIG. 18, the output timing of encoded data is dispersed as shown in FIG. 19. The loads of the downstream processes can be thus made uniform, making it easier to perform processing in real time with respect image data inputted at a substantially constant speed like a playback video signal (image data inputted per one line at a predetermined interval). For example, in a case where encoded data is packetized as a process downstream of the encoding section 10, if the generating rate of encoded data is substantially constant as in the case of FIG. 18, the amount of variation in load of the packetization process is reduced, thus facilitating the packetization process. In the case of FIG. 12, in contrast, the output timing of encoded data is concentrated in the period during which an entropy encoding process is performed, resulting in non-uniformity. The amount of variation in load of a packetization process thus increases, which makes it necessary to execute the packetization process at high speed or to buffer encoded data so that no overflow occurs at the peak load. This may lead to an increase in cost, load, and delay time.

It should be noted that the arrangement shown in FIG. 18 is merely an example, and an entropy encoding process can be assigned to any arbitrary free time during a lifting process. For example, while in FIG. 18 encoding (VLC5 and VLC6) of the pieces of coefficient data that are subjected to a synthesis filtering process in the fifth and sixth turns is assigned to the free time after the lifting operation DWT(Lev1) executed after image data of line number 24 (and 23) is inputted, encoding (VLC 7 to VLC 12) of the pieces of coefficient data that are subjected to a synthesis filtering process in the seventh turn onwards may be additionally assigned. Further, encoding may be assigned to the free time after the lifting operations DWT(Lev1), DWT(Lev2), and DWT(Lev3) executed after image data of line number 30 (and 29) is inputted.

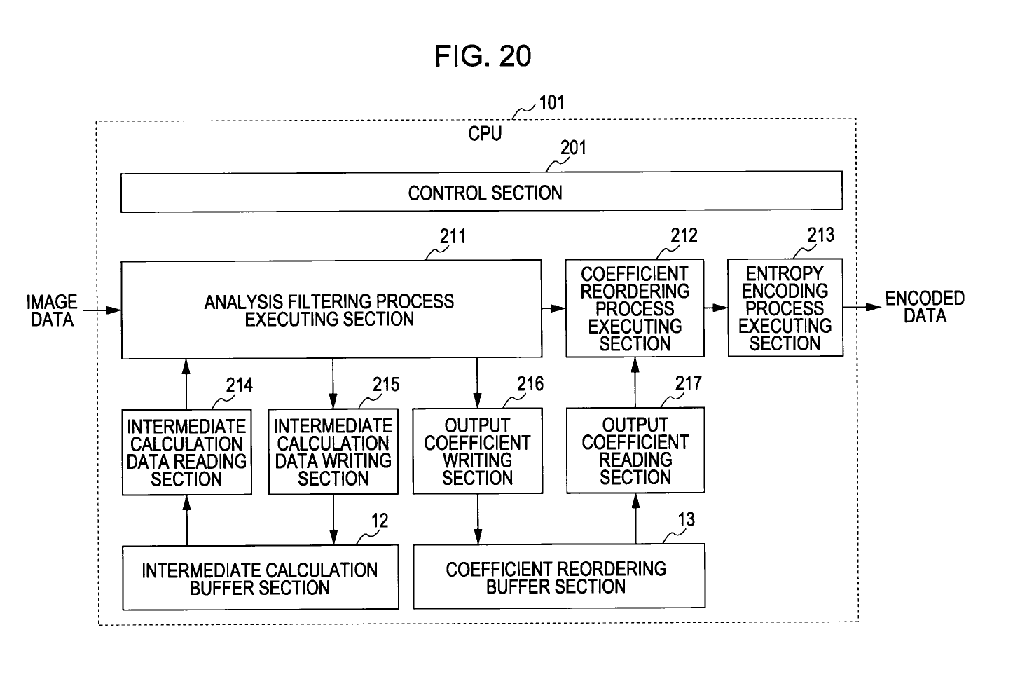

Next, a more specific description will be given of how the encoding section 10 that executes processes in accordance with the above-mentioned flow is realized. FIG. 20 is a functional block diagram showing functions included in the CPU 101 that executes a software program for realizing the encoding section 10 that executes processes in accordance with the above-mentioned flow.

FIG. 20 corresponds to FIG. 14, and blocks corresponding to the blocks shown in FIG. 14 are denoted by the same reference numerals. In FIG. 20, only the image data buffer section 221 is omitted as compared with FIG. 14, and the CPU 101 has basically the same functional blocks as those in FIG. 14. Thus, the CPU 101 has the control section 201, the analysis filtering process executing section 211, the coefficient reordering process executing section 212, the entropy encoding process executing section 213, the intermediate calculation data reading section 214, the intermediate calculation data writing section 215, the output coefficient writing section 216, and the output coefficient reading section 217. It should be noted, however, that in the case of FIG. 20, the control section 201 does not perform a control related to the image data buffer section 221.

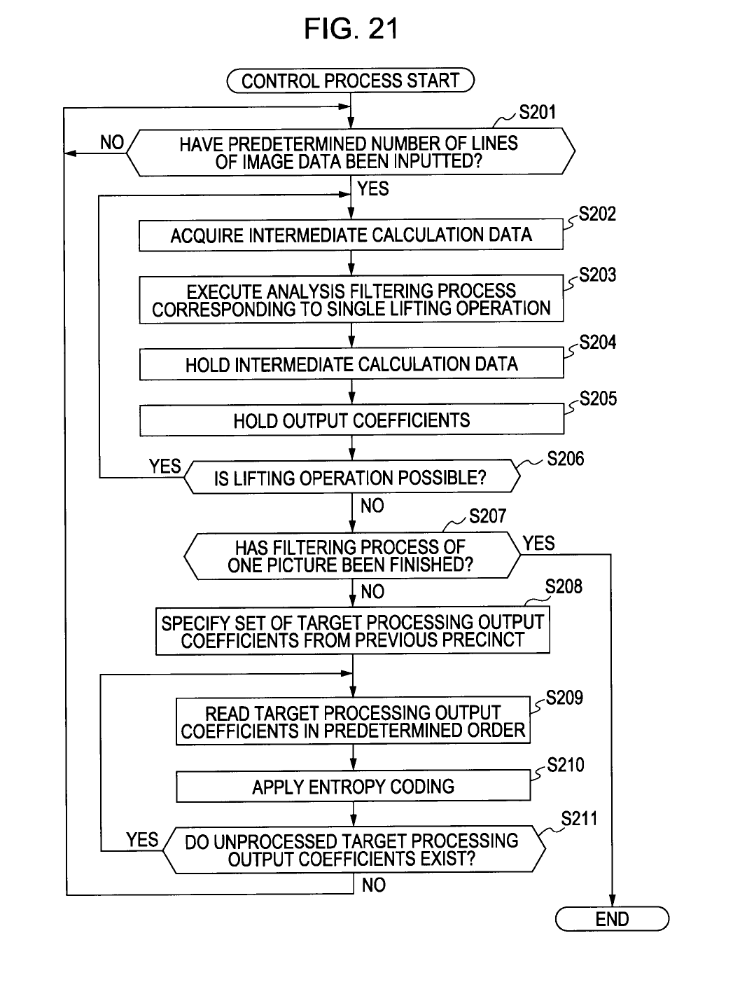

The control section 201 shown in FIG. 20 executes a control process of controlling respective sections to realize the encoding section 10 shown in FIG. 1. An example of the flow of the control process will be described with reference to the flowchart of FIG. 21. It should be noted that this control process is repeatedly executed for each picture of image data.

When the control process is started, in step S201, the control section 201 determines whether or not a predetermined number of lines (for example, two or three lines) of image data have been inputted, and waits on standby until it is determined that the predetermined number of lines of image data have been inputted. Then, if it is determined that the predetermined number of lines of image data have been inputted, the control section 201 advances the process to step S202.

In step S202, the control section 201 controls the analysis filtering process executing section 211 to acquire, from the intermediate calculation buffer section 12, intermediate calculation data necessary for the lifting operation that is going to be performed next. Through this control, the analysis filtering process executing section 211 controls the intermediate calculation data reading section 214 to read, from the intermediate calculation buffer section 12, intermediate calculation data necessary for the lifting operation that is going to be performed next, and to supply the intermediate calculation data to the analysis filtering process executing section 211 (that is, the analysis filtering process executing section 211 acquires intermediate calculation data). Through this control, the intermediate calculation data reading section 214 reads the requested intermediate calculation data from the intermediate calculation buffer section 12, and supplies the read data to the analysis filtering process executing section 211.

In step S203, the control section 201 controls the analysis filtering process executing section 211 to execute a single lifting operation of an analysis filtering process. Through this control, as described above with reference to FIG. 18, the analysis filtering process executing section 211 executes a single lifting operation of an analysis filtering process that can be executed.

When the lifting operation is performed, in step S204, the control section 201 controls the analysis filtering process executing section 211 to hold, from among image data and coefficient data used in the lifting operation and coefficient data obtained by the lifting operation, those pieces of data which are to be used for the subsequent lifting operations, in the intermediate calculation buffer section 12 as intermediate calculation data. Through this control, the analysis filtering process executing section 211 supplies intermediate calculation data to the intermediate calculation data writing section 215, and also controls the intermediate calculation data writing section 215 to write the supplied intermediate calculation data into the intermediate calculation buffer section 12. Through this control, the intermediate calculation data writing section 215 writes the intermediate calculation data supplied from the analysis filtering process executing section 211 into the intermediate calculation buffer section 12 to be held therein.

In step S205, the control section 201 controls the analysis filtering process executing section 211 to hold output coefficients obtained by the lifting operation into the coefficient reordering buffer section 13. Through this control, the analysis filtering process executing section 211 supplies output coefficients to the output coefficient writing section 216, and controls the output coefficient writing section 216 to write the supplied output coefficients into the coefficient reordering buffer section 13. Through this control, the output coefficient writing section 216 writes the output coefficients supplied from the analysis filtering process executing section 211 into the coefficient reordering buffer section 13 to be held therein.

In step S206, the control section 201 determines whether or not a lifting operation is possible without input of additional image data. If it is determined that a lifting operation is possible, the control section 201 returns the process to step S202, and repeats the subsequent processes. That is, as described above with reference to FIG. 18, the control section 201 repeats the processes of step S202 to step S206 to perform all the lifting operations that can be executed in correspondence to inputted image data.

Then, if it is determined in step S206 that there are no more lifting operations that can be executed, the control section 201 advances the process to step S207.

In step S207, the control section 201 determines whether or not a filtering process of one picture has been finished. If it is determined that a filtering process of one picture has not been finished, the control section 201 advances the process to step S208, where the control section 201 specifies a set of target processing output coefficients from the previous precinct held in the coefficient reordering buffer section 13. That is, the control section 201 specifies the output coefficients that are to be encoded during the free time until the start timing of the next lifting operation, from among frequency components generated earlier than the frequency components of the lowest frequency band generated last by the lifting operation. It should be noted that if it is the first precinct that has been subjected to an analysis filtering process, the control section 201 sets the last precinct of the previous picture as the previous precinct, and specifies a set of target processing output coefficients from that previous precinct. Further, if it is the first precinct of the top picture that has been subjected to an analysis filtering process, the control section 201 omits the processes from step S208 to step S211, returns the process to step S201, and executes the subsequent processes.

In step S209, the control section 201 controls the coefficient reordering process executing section 212 to read pieces of coefficient data specified as the target processing output coefficients, in a predetermined order. Through this control, the coefficient reordering process executing section 212 controls the output coefficient reading section 217 to read pieces of coefficient data (target processing output coefficients) held in the coefficient reordering buffer section 13 in the order in which they are subjected to a synthesis filtering process, and to supply the read pieces of coefficient data to the coefficient reordering process executing section 212. Through this control, the output coefficient reading section 217 reads pieces of coefficient data held in the coefficient reordering buffer section 13 in the order in which they are subjected to a synthesis filtering process, and supplies the read pieces of coefficient data to the coefficient reordering process executing section 212. The coefficient reordering process executing section 212 sequentially supplies the supplied pieces of coefficient data to the entropy encoding process executing section 213.

In step S210, the control section 201 controls the entropy encoding process executing section 213 to apply entropy encoding to the coefficient data read from the coefficient reordering buffer section 13. Through this control, the entropy encoding process executing section 213 encodes the read coefficient data, and outputs the obtained encoded data.

In step S211, the control section 201 determines whether or not target processing output coefficients that have not been encoded exist in the coefficient reordering buffer section 13. If it is determined that such output coefficients exist, the control section 201 returns the process to step S209, and repeats the subsequent processes. That is, by repeating the processes from step S209 to step S211, the control section 201 executes an encoding process with respect to all the target processing output coefficients held in the coefficient reordering buffer section 13.

If it is determined in step S211 that target processing output coefficients that have not been processed do not exist in the coefficient reordering buffer section 13, the control section 201 returns the process to step S201, and repeats the subsequent processes. That is, by repeating the processes from step S201 to step S211, the control section 201 executes a wavelet transform process with respect to all the precincts within a picture, and further executes an entropy encoding process during a free time within the wavelet transform process, thereby executing the wavelet transform process and the entropy encoding process apparently in a simultaneous parallel manner.

If it is determined in step S207 that a filtering process of one picture has been finished, the control section 201 terminates the control process. It should be noted that if this control process is performed with respect to the last picture of image data, the control section 201 specifies all the remaining output coefficients held in the coefficient reordering buffer section 13 as a set of target processing output coefficients, performs the same processes as those from step S209 to step S211 to encode all the output coefficients and output the resulting encoded data, and then terminates the control process.

Through the above-mentioned control process, the control section 201 can easily execute a wavelet transform process and an entropy encoding process in a simultaneous parallel manner to generate encoded data in real time from image data inputted at a predetermined speed and output the generated encoded data. This also makes it unnecessary to hold input image data. In this way, it is possible to reduce the load due to a wavelet transform process and an encoding process.

While FIG. 21 is directed to a flow of control process, as described above, the respective sections from the analysis filtering process executing section 211 to the output coefficient reading section 217 execute processes corresponding to the control of the control section 201 in correspondence to the respective steps of this control process. Therefore, since the respective steps of the control process shown in the flowchart of FIG. 21 are regarded as also representing processes executed by the respective sections from the analysis filtering process executing section 211 to the output coefficient reading section 217, illustration of the processes executed by these respective sections is omitted.

Next, another way of advancing processes will be described.

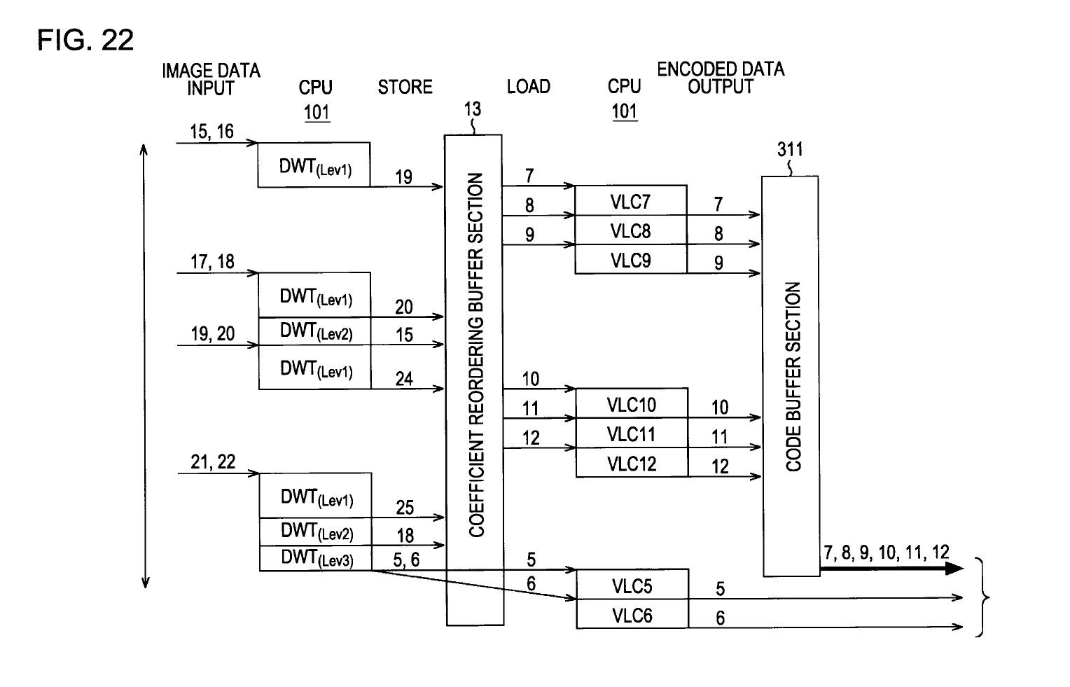

As described above with reference to FIG. 11, the encoding process with respect to the second precinct in the decoding section 20 cannot be started until the wavelet transform process with respect to the second precinct in the encoding section 10 is finished. In view of this, as shown in FIG. 22, it is also possible to provide a code buffer section 311 that holds encoded data, so that encoding is applied to coefficient data generated earlier than the last lifting operation of the wavelet transform process with respect to the second precinct in the encoding section 10, before the last lifting operation. That is, in this case, the CPU 101 first performs the entropy encoding process in the order different from the processing order in the synthesis filtering process, and holds the obtained pieces of encoded data, thus causing the pieces of encoded data to be outputted in the order in which they are processed in the synthesis filtering process.

FIG. 22 schematically shows the flow of processes executed in the CPU 101 in this case. FIG. 22 corresponds to FIG. 12 and shows basically the same configuration as that of FIG. 12, so its detailed description is omitted.

In FIG. 22 as well, as in the case of FIG. 12, the CPU 101 performs a lifting operation (analysis filtering process) that can be executed every time two lines of image data are inputted, with respect to the second precinct in the encoding section 10 (DWT(Lev1) to DWT(Lev3)). It should be noted, however, that as in the case of FIG. 18, during the period of time after the end of a lifting operation until the input of the next two lines of data (until the timing of starting the execution of the next lifting operation), the CPU 101 executes an entropy encoding process with respect to the second precinct in the decoding section 20, per line of coefficient data.

It should be noted, however, that in the case of FIG. 22, this entropy encoding process is applied to the same precinct as the precinct to which a wavelet transform is to be applied. The relationship between the wavelet transform process and the entropy encoding process in this case is not the one shown in FIG. 17 but becomes as shown in FIG. 11. That is, as described above, at the point in time when the analysis filtering process with respect to the second precinct is started, pieces of coefficient data that are subjected to a synthesis filtering process in the fifth and sixth turns have not been generated. In the case of FIG. 22, prior to encoding of these pieces of coefficient data, the CPU 101 applies encoding to other pieces of coefficient data of the second precinct in the decoding section 20 which have been already generated and held in the coefficient reordering buffer section 13 (that is, pieces of coefficient data subjected to a synthesis filtering process in the seventh to twelfth turns, which correspond to the pieces of coefficient data that are subjected to a synthesis filtering process in the fifth and sixth turns and are higher-frequency components than those pieces of coefficient data).

In the case of FIG. 22, unlike in the examples described above, the code buffer section 311 that holds encoded data is provided. Other pieces of coefficient data in a target processing precinct that are encoded earlier than the pieces of coefficient data generated by the last lifting operation in the target processing precinct are temporarily held in the code buffer section 311. Then, when the pieces of coefficient data generated by the last lifting operation in the target processing precinct are encoded and outputted, pieces of encoded data held in the code buffer section 311 are read and outputted in the order in which they are subjected to a synthesis filtering process.

More specifically, in the case of FIG. 22, when image data of line number 16 (and 15) is inputted, the CPU 101 performs lifting operation DWT(Lev1) of the portion enclosed by the curved line 161 in FIG. 11 to generate coefficient data that is subjected to a synthesis filtering process in the nineteenth turn, and holds the coefficient data in the coefficient reordering buffer section 13. Thereafter, by making use of the time left until the timing of starting the execution of the next lifting operation, the CPU 101 sequentially applies entropy encoding to pieces of coefficient data that are subjected to a synthesis filtering process in the seventh to ninth turns (VLC7, VLC8, and VLC9), and holds the encoded data obtained through the respective processes in the code buffer section 311.

Then, when image data of line number 18 (and 17) is inputted, the CPU 101 performs lifting operations DWT(Lev1) and DWT(Lev2) of the portion enclosed by the curved line 162 in FIG. 11 to generate pieces of coefficient data that are subjected to a synthesis filtering process in the twentieth and fifteenth turns, respectively, and holds those pieces of coefficient data in the coefficient reordering buffer section 13.

Further, when image data of line number 20 (and 19) is inputted, the CPU 101 performs lifting operation DWT(Lev1) of the portion enclosed by the curved line 163 in FIG. 11 to generate coefficient data that is subjected to a synthesis filtering process in the twenty-fourth turn, and holds the coefficient data in the coefficient reordering buffer section 13. Thereafter, by making use of the time left until the timing of starting the execution of the next lifting operation, the CPU 101 sequentially applies entropy encoding to pieces of coefficient data that are subjected to a synthesis filtering process in the tenth to twelfth turns (VLC10, VLC11, and VLC12), and holds the encoded data obtained through the respective processes in the code buffer section 311.

When image data of line number 22 (and 21) is inputted, the CPU 101 performs lifting operations DWT(Lev1), DWT(Lev2), and DWT(Lev3) of the portion enclosed by the curved line 164 in FIG. 11 to generate pieces of coefficient data that are subjected to a synthesis filtering process in the twenty-fifth, eighteenth, fifth, and sixth turns, and sequentially holds the pieces of coefficient data that are subjected to the twenty-fifth and eighteenth turns in the coefficient reordering buffer section 13. Thereafter, by making use of the time left until the timing of starting the execution of the next lifting operation, the CPU 101 sequentially applies entropy encoding to pieces of coefficient data that are subjected to a synthesis filtering process in the fifth and sixth turns (VLC5 and VLC6), and outputs the pieces of encoded data obtained through the respective processes. Then, the CPU 101 reads the encoded data of the pieces of coefficient data that are subjected to a synthesis filtering process in the seventh to twelfth turns, which are held in the code buffer section 311, in the order in which they are subjected to a synthesis filtering process, and outputs the encoded data succeeding to the encoded data of the pieces of coefficient data that are subjected to a synthesis filtering process in the fifth and sixth turns.

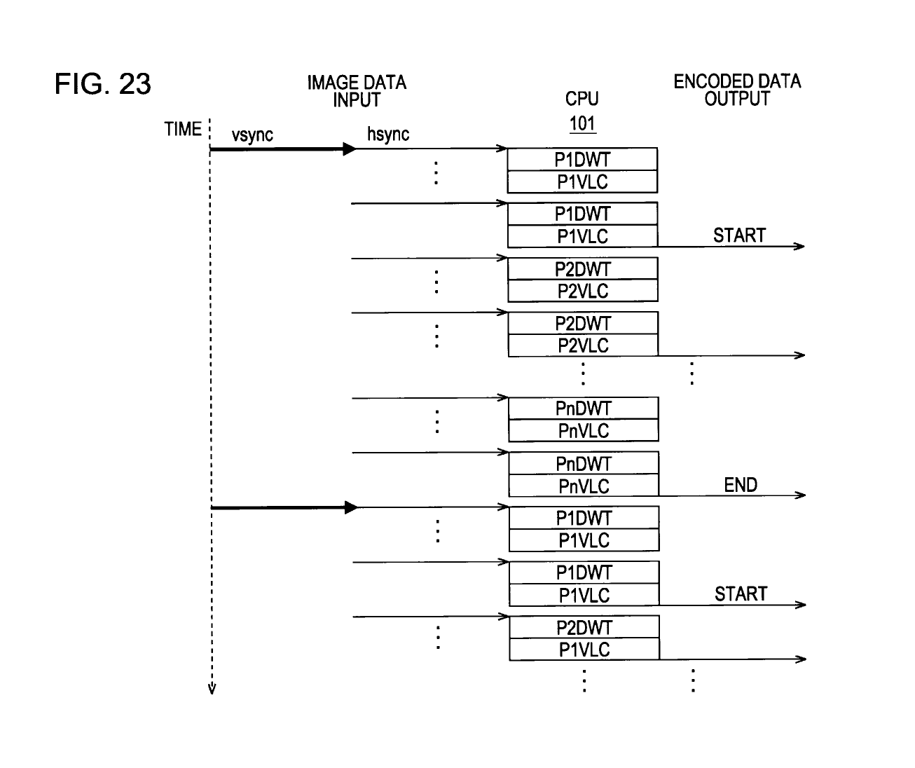

That is, as shown in FIG. 23, with respect to image data inputted at a predetermined speed, a wavelet transform process and an entropy encoding process can be executed in real time without staggering the precincts. This allows the CPU 101 to output generated encoded data before an analysis filtering process with respect to the next precinct is started, thereby making it possible to enhance the usage frequency of the CPU 101 while keeping the output timing of each encoded data the same as it is in the case of FIG. 12. Further, in the case of FIG. 22, the image data buffer section 221 can be omitted.

However, in the case of FIG. 22, the code buffer section 311 is required, so the required memory capacity increases as compared with the case of FIG. 18. However, since encoded data is accumulated in the code buffer section 311, the amount of accumulated data is reduced as compared with a case where image data is accumulated. That is, the memory capacity required for data buffering can be reduced as compared with the case of FIG. 12.

Comparing FIGS. 18 and 22 with each other, the usage frequency of the CPU 101 is higher in the case of FIG. 22 because an entropy encoding process can be applied starting with the precinct at the beginning of the first picture. However, the required memory capacity increases due to the provision of the code buffer section 311. Also, since there is non-uniformity in the output timing of encoded data, the processes downstream of the encoding section 10 become more difficult (load may increase) in the case of FIG. 22.

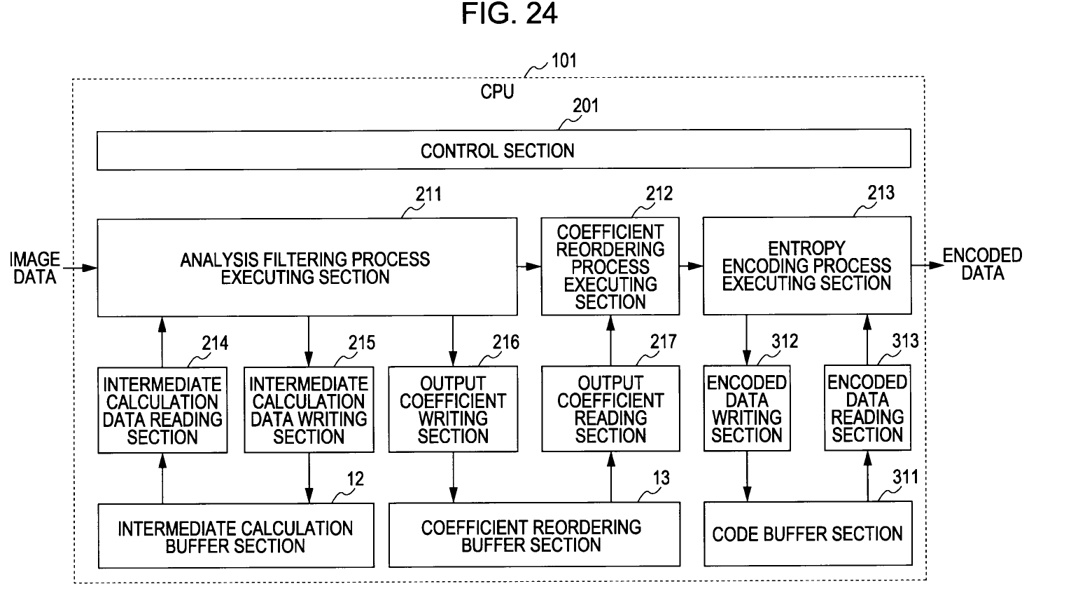

Next, a more specific description will be given of how the encoding section 10 that executes processes in accordance with the above-mentioned flow is realized. FIG. 24 is a functional block diagram showing functions included in the CPU 101 that executes a software program for realizing the encoding section 10 that executes processes in accordance with the above-mentioned flow.

FIG. 24 also corresponds to FIG. 14, and blocks corresponding to the blocks shown in FIG. 14 are denoted by the same reference numerals. In FIG. 24, the CPU 101 has basically the same functional blocks as those in FIG. 20, except that the CPU 101 further has the code buffer section 311, an encoded data writing section 312, and an encoded data reading section 313.

The encoded data writing section 312 and the encoded data reading section 313 are controlled by the control section 201 to read or write encoded data generated by an entropy encoding process to or from a cache memory (not shown), the RAM 103, or the like, thereby forming the code buffer section 311 shown in FIG. 22 in the storage area of the cache memory (not shown), the RAM 103, or the like. The encoded data writing section 312 writes (holds) encoded data supplied from the entropy encoding process executing section 213 into the encoded buffer section 311. The encoded data reading section 313 reads pieces of encoded data held in the code buffer section 311 in the order in which they are subjected to a synthesis filtering process, and supplies the read pieces of encoded data to the entropy encoding process executing section 213.

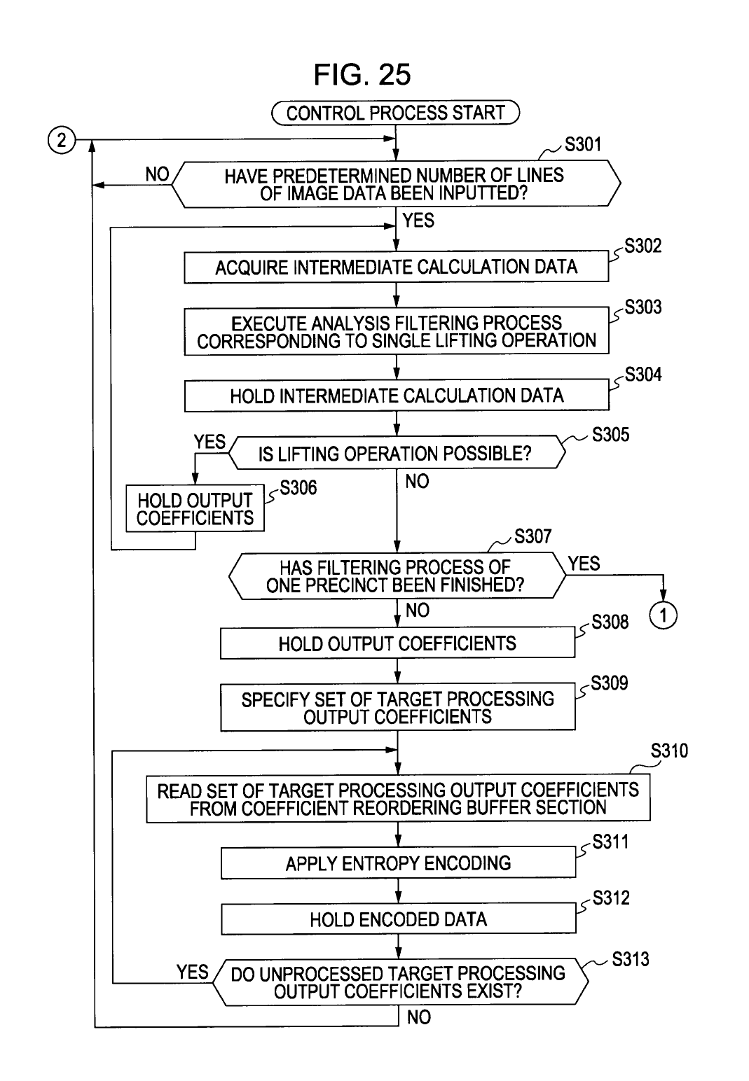

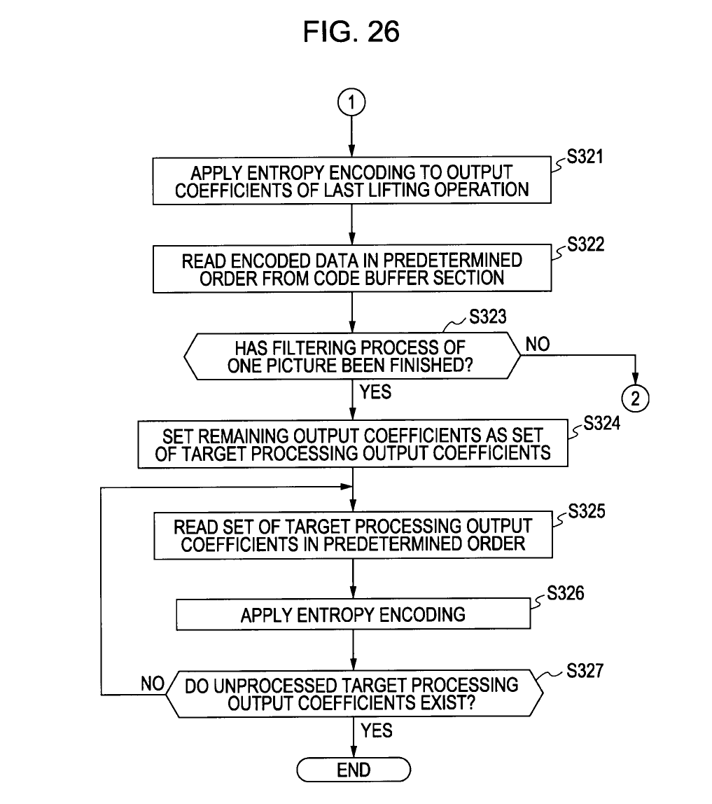

The control section 201 shown in FIG. 24 executes a control process of controlling respective sections to realize the encoding section 10 shown in FIG. 1. An example of the flow of the control process will be described with reference to the flowcharts of FIGS. 25 and 26. It should be noted that this control process is repeatedly executed for each picture of image data.

When the control process is started, in step S301, the control section 201 determines whether or not a predetermined number of lines (for example, two or three lines) of image data have been inputted, and waits on standby until it is determined that the predetermined number of lines of image data have been inputted. Then, if it s determined that the predetermined number of lines of image data have been inputted, the control section 201 advances the process to step S302.

In step S302, the control section 201 controls the analysis filtering process executing section 211 to acquire, from the intermediate calculation buffer section 12, intermediate calculation data necessary for the lifting operation that is going to be performed next. Through this control, the analysis filtering process executing section 211 controls the intermediate calculation data reading section 214 to read, from the intermediate calculation buffer section 12, intermediate calculation data necessary for the lifting operation that is going to be performed next, and to supply the intermediate calculation data to the analysis filtering process executing section 211 (that is, the analysis filtering process executing section 211 acquires intermediate calculation data). Through this control, the intermediate calculation data reading section 214 reads the requested intermediate calculation data from the intermediate calculation buffer section 12, and supplies the read data to the analysis filtering process executing section 211.

In step S303, the control section 201 controls the analysis filtering process executing section 211 to execute a single lifting operation of an analysis filtering process. Through this control, as described above with reference to FIG. 22, the analysis filtering process executing section 211 executes a single lifting operation of an analysis filtering process that can be executed.

When the lifting operation is performed, in step S304, the control section 201 controls the analysis filtering process executing section 211 to hold, from among image data and coefficient data used in the lifting operation and coefficient data obtained by the lifting operation, those pieces of data which are to be used for the subsequent lifting operations, in the intermediate calculation buffer section 12 as intermediate calculation data. Through this control, the analysis filtering process executing section 211 supplies intermediate calculation data to the intermediate calculation data writing section 215, and also controls the intermediate calculation data writing section 215 to write the supplied intermediate calculation data into the intermediate calculation buffer section 12. Through this control, the intermediate calculation data writing section 215 writes the intermediate calculation data supplied from the analysis filtering process executing section 211 into the intermediate calculation buffer section 12 to be held therein.

In step S305, the control section 201 determines whether or not a lifting operation is possible without input of additional image data. If it is determined that a lifting operation is possible, the control section 201 advances the process to step S306.

In step S306, the control section 201 controls the analysis filtering process executing section 211 to hold output coefficients obtained by the lifting operation into the coefficient reordering buffer section 13. Through this control, the analysis filtering process executing section 211 supplies output coefficients to the output coefficient writing section 216, and controls the output coefficient writing section 216 to write the supplied output coefficients into the coefficient reordering buffer section 13. Through this control, the output coefficient writing section 216 writes the output coefficients supplied from the analysis filtering process executing section 211 into the coefficient reordering buffer section 13 to be held therein.

When the process of step S306 is finished, the control section 201 returns the process to step S302, and repeats the subsequent processes. That is, as described above with reference to FIG. 22, the control section 201 repeats the processes of step S302 to step S306 to perform all the lifting operations that can be executed in correspondence to inputted image data.

If it is determined in step S305 that there are no more lifting operations that can be executed, the control section 201 advances the process to step S307. In step S307, the control section 201 determines whether or not a filtering process of one precinct has been finished. If it is determined that a filtering process of one precinct has not been finished, the control section 201 advances the process to step S308.

In step S308, the control section 201 controls the analysis filtering process executing section 211 to hold output coefficients obtained by the lifting operation into the coefficient reordering buffer section 13. Through this control, the analysis filtering process executing section 211 supplies output coefficients to the output coefficient writing section 216, and controls the output coefficient writing section 216 to write the supplied output coefficients into the coefficient reordering buffer section 13. Through this control, the output coefficient writing section 216 writes the output coefficients supplied from the analysis filtering process executing section 211 into the coefficient reordering buffer section 13 to be held therein.

In step S309, the control section 201 specifies a set of target processing output coefficients from the coefficient data of the current target processing precinct held in the coefficient reordering buffer section 13. That is, the control section 201 specifies the output coefficients that are to be encoded during the free time until the timing of starting the next lifting operation.

In step S310, the control section 201 controls the coefficient reordering process executing section 212 to read pieces of coefficient data specified as the target processing output coefficients, in a predetermined order. Through this control, the coefficient reordering process executing section 212 controls the output coefficient reading section 217 to read pieces of coefficient data (target processing output coefficients) held in the coefficient reordering buffer section 13 in the order in which they are subjected to a synthesis filtering process, and to supply the read pieces of coefficient data to the coefficient reordering process executing section 212. Through this control, the output coefficient reading section 217 reads pieces of coefficient data held in the coefficient reordering buffer section 13 in the order in which they are subjected to a synthesis filtering process, and supplies the read pieces of coefficient data to the coefficient reordering process executing section 212. The coefficient reordering process executing section 212 sequentially supplies the supplied pieces of coefficient data to the entropy encoding process executing section 213.

In step S311, the control section 201 controls the entropy encoding process executing section 213 to apply entropy encoding to the coefficient data read from the coefficient reordering buffer section 13. Through this control, the entropy encoding process executing section 213 encodes the read coefficient data.

In step S312, the control section 201 controls the entropy encoding process executing section 213 to hold the encoded data generated in step S311 into the code buffer section 311. Through this control, the entropy encoding process executing section 213 supplies encoded data to the encoded data writing section 312, and controls the encoded data writing section 312 to write the supplied encoded data into the code buffer section 311. Through this control, the encoded data writing section 312 writes the output coefficients supplied from the entropy encoding process executing section 213 into the code buffer section 311 to be held therein.

In step S313, the control section 201 determines whether or not target processing output coefficients that have not been encoded exist in the coefficient reordering buffer section 13. If it is determined that such output coefficients exist, the control section 201 returns the process to step S310, and repeats the subsequent processes. That is, by repeating the processes from step S310 to step S313, the control section 201 executes an encoding process with respect to all the target processing output coefficients held in the coefficient reordering buffer section 13.

If it is determined in step S313 that target processing output coefficients that have not been processed do not exist in the coefficient reordering buffer section 13, the control section 201 returns the process to step S301, and repeats the subsequent processes. That is, by repeating the processes from step S301 to step S313, the control section 201 executes a wavelet transform process with respect to all the precincts within a picture, and further executes an entropy encoding process during a free time in the wavelet transform process, thereby executing the wavelet transform process and the entropy encoding process apparently in a simultaneous parallel manner.

If it is determined in step S307 that a filtering process of one precinct has been finished, the control section 201 advances the process to step S321 in FIG. 26.

In step S321 in FIG. 26, the control section 201 controls the entropy encoding process executing section 213 to apply entropy encoding to output coefficients of the last lifting operation. That is, the output coefficients of the last lifting operation are entropy encoded without the intermediation of the coefficient reordering buffer section 13.

Through the control of step S321, the entropy encoding process executing section 213 applies encoding to, for example, coefficient data that is subjected to a synthesis filtering process in the fifth turn and coefficient data that is subjected to a synthesis filtering process in the sixth turn in order, and sequentially outputs the obtained pieces of encoded data.

When the above encoding process is finished, in step S322, the control section 201 controls the encoded data reading section 313 to read pieces of encoded data in a predetermined order from the code buffer section 311. Through this control, the encoded data reading section 313 reads pieces of encoded data held in the code buffer section 311 in the order in which they are subjected to a synthesis filtering process, for example, and supplies the read pieces of encoded data to the entropy encoding process executing section 213. The entropy encoding process executing section 213 outputs the supplied encoded data succeeding to the encoded data encoded and outputted in step S321.

In step S323, the control section 201 determines whether or not a filtering process of one picture has been finished. If it is determined that a filtering process of one picture has not been finished, the control section 201 returns the process to step S301 in FIG. 25, and repeats the subsequent processes.

If it is determined in step S323 that a filtering process of one picture has been finished, the control section 201 advances the process to step S324, and sets the remaining output coefficients held in the coefficient reordering buffer section 13 as a set of target processing output coefficients.

In step S325, the control section 201 controls the coefficient reordering process executing section 212 to read pieces of coefficient data specified as the target processing output coefficients, in a predetermined order. Through this control, the coefficient reordering process executing section 212 controls the output coefficient reading section 217 to read pieces of coefficient data (target processing output coefficients) held in the coefficient reordering buffer section 13 in the order in which they are subjected to a synthesis filtering process, and to supply the read pieces of coefficient data to the coefficient reordering process executing section 212. Through this control, the output coefficient reading section 217 reads pieces of coefficient data held in the coefficient reordering buffer section 13 in the order in which they are subjected to a synthesis filtering process, and supplies the read pieces of coefficient data to the coefficient reordering process executing section 212. The coefficient reordering process executing section 212 sequentially supplies the supplied pieces of coefficient data to the entropy encoding process executing section 213.

In step S326, the control section 201 controls the entropy encoding process executing section 213 to apply entropy encoding to coefficient data read from the coefficient reordering buffer section 13. Through this control, the entropy encoding process executing section 213 encodes the read coefficient data, and outputs the obtained encoded data.

In step S327, the control section 201 determines whether or not target processing output coefficients that have not been encoded exist in the coefficient reordering buffer section 13. If it is determined that such output coefficients exist, the control section 201 returns the process to step S325, and repeats the subsequent processes.

If it is determined in step S327 that target processing output coefficients that have not been processed do not exist in the coefficient reordering buffer section 13, the control section 201 terminates the control process.

By performing the above-described control process, the control section 201 executes a wavelet transform process and an entropy encoding process in a simultaneous parallel manner, thereby making it easier to generate encoded data in real time from image data inputted at a predetermined speed and output the generated encoded data. This also makes it unnecessary to hold input image data. Further, since encoded data can be thus set as the data to be held, it is possible to reduce the memory capacity required for the process, and reduce the load due to a wavelet transform process and an encoding process.

While FIGS. 25 and 26 are directed to a flow of control process, as described above, the respective sections from the analysis filtering process executing section 211 to the output coefficient reading section 217 execute processes corresponding to the control of the control section 201 in correspondence to the respective steps of this control process. Therefore, since the respective steps of the control process shown in the flowcharts of FIGS. 25 and 26 are regarded as also representing processes executed by the respective sections from the analysis filtering process executing section 211 to the encoded data reading section 313, illustration of the processes executed by these respective sections is omitted.

The foregoing description is directed to a case where, as described above with reference to FIG. 10, a software program is executed in the personal computer 100 having one CPU as an arithmetic processing section. However, in recent years, many types of information processing device have a plurality of CPUs. There are also cases where an information processing device has only one CPU, but the CPU has a plurality of cores that can operate independently from each other. An information processing device having a plurality of arithmetic processing sections that operate independently from each other as described above can execute a plurality of processes in parallel with each other. In the following, a description will be given of a case where the software encoder described above is realized using such an information processing device having a plurality of arithmetic processing sections that operate independently from each other.

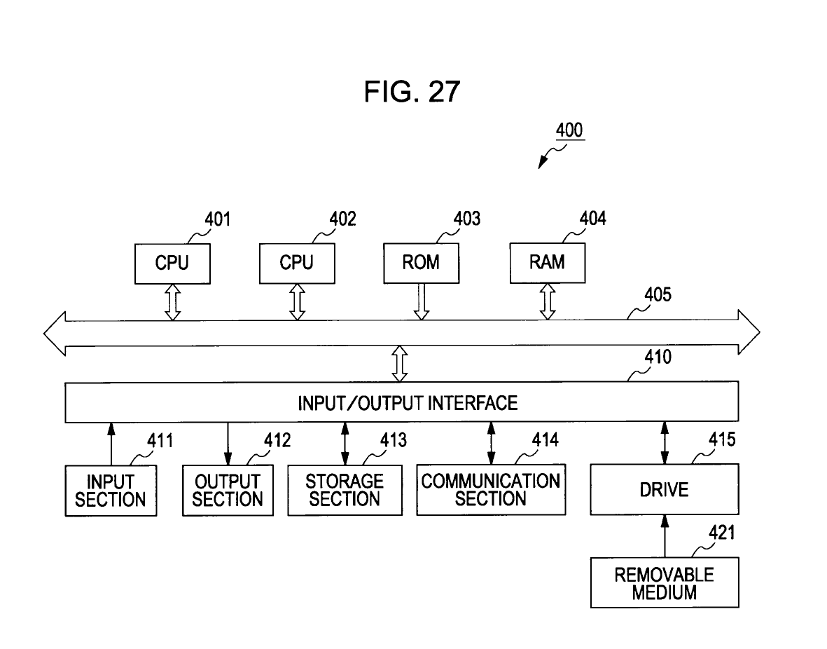

FIG. 27 is a block diagram showing another example of the configuration of a personal computer. A personal computer 400 shown in FIG. 27 has basically the same configuration as that of the personal computer 100 shown in FIG. 10. That is, the personal computer 400 has a ROM 403 similar to the ROM 102 of the personal computer 100, a RAM 404 similar to the RAM 103 of the personal computer 100, a bus 405 similar to the bus 104 of the personal computer 100, an input/output interface 410 similar to the input/output interface 110 of the personal computer 100, an input section 411 similar to the input section 111 of the personal computer 100, an output section 412 similar to the output section 112 of the personal computer 100, a storage section 413 similar to the storage section 113 of the personal computer 100, a communication section 414 similar to the communication section 114 of the personal computer 100, and a drive 415 similar to the drive 115 of the personal computer 100. A removable medium 421 similar to the removable medium 121 of the personal computer 100 is mounted in the drive 415 as appropriate.

However, unlike the personal computer 100 having one CPU 101, the personal computer 400 has a CPU 401 and a CPU 402. Each of the CPU 401 and the CPU 402 is basically the same as the CPU 101. The CPU 401 and the CPU 402 can execute processes independently from each other. That is, the personal computer 400 has two arithmetic processing sections (the CPU 401 and the CPU 402) that operate independently from each other.

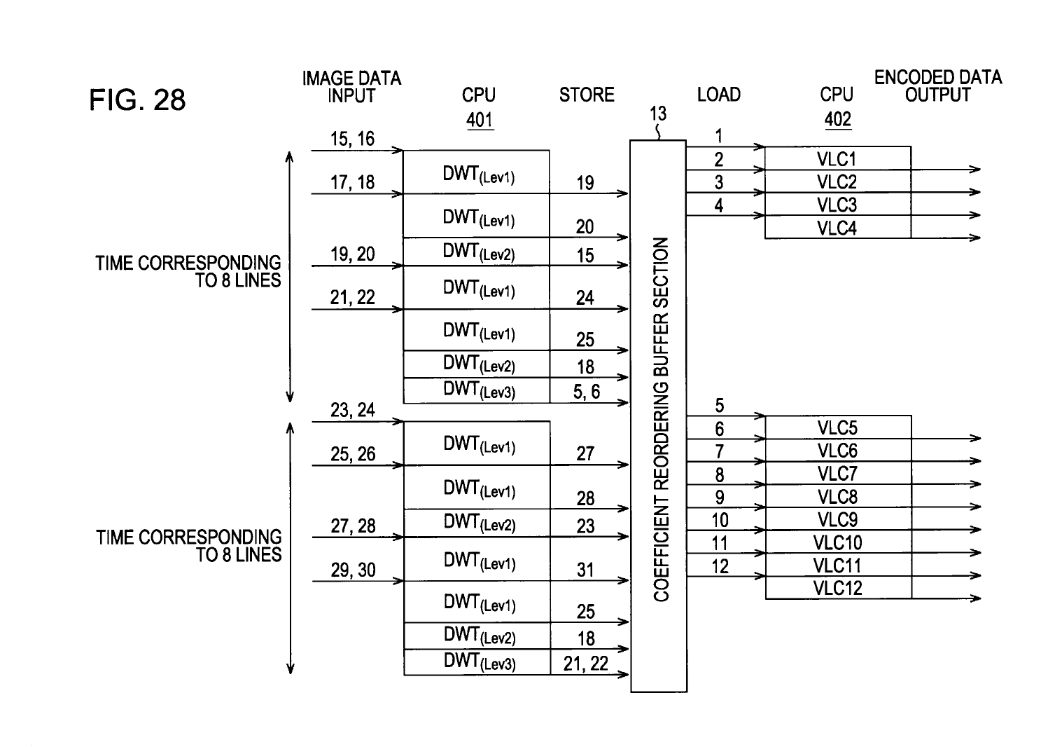

To realize the encoding section 10 shown in FIG. 1 by the personal computer 400 described above, processes are executed as shown in FIG. 28 using the CPU 401 and the CPU 402. FIG. 28 schematically shows the flow of processes executed in the CPU 401 and the CPU 402. FIG. 28 corresponds to FIG. 12 and shows basically the same configuration as that of FIG. 12, so its detailed description is omitted.

In the case of the example in FIG. 28, since there are two arithmetic processing sections (the CPU 401 and the CPU 402) that operate independently from each other, a wavelet transform process is executed in the CPU 401 as one of the arithmetic processing sections, and an entropy encoding process is executed in the CPU 402 as the other arithmetic processing section. In this way, the wavelet transform process and the entropy encoding process can be executed in parallel with each other. In the case of the example in FIG. 28, unlike in the above-described example, two processes are not operated apparently in parallel by time-sharing but are actually operated in parallel using two arithmetic processing sections.

As in the other examples described above, the CPU 401 performs a lifting operation (DWT) that can be executed every time two lines of image data are inputted, generates output coefficients, and hold the output coefficients in the coefficient reordering buffer section 13. During the execution of this analysis filtering process, in parallel with this analysis filtering process, the other CPU 401 reads output coefficients accumulated in the coefficient reordering buffer section 13 in the order in which they are subjected to a synthesis filtering process, applies entropy encoding (VLC) to the read output coefficients, and sequentially outputs the obtained pieces of coefficient data.

By using two arithmetic processing sections in this way, the load on each CPU is reduced. Therefore, even in the case of a CPU that operates at lower speed than that in the case of the other examples described above, a wavelet transform process and an entropy encoding process can be easily executed in real time with respect to image data inputted at a predetermined speed, without causing overflow.

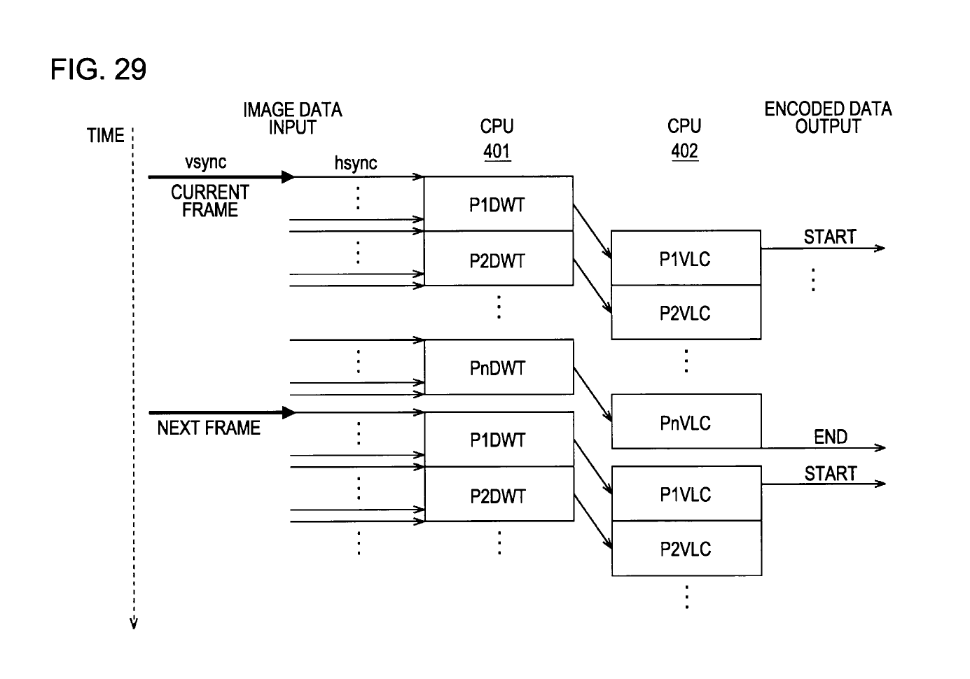

As shown in FIG. 29, in this case, in parallel with the CPU 401 applying a wavelet transform (P2DWT) to the second precinct, the CPU 402 applies entropy encoding to the first precinct (P1VLC). Therefore, the delay time in this case is substantially the same as that in the other examples described above. Since the CPU 402 performs only an encoding process, the output timing of encoded data can be dispersed as appropriate. Therefore, processes downstream of the encoding section 10 are facilitated.

Further, as shown in FIG. 28, in parallel with the CPU 401 holding output coefficients into the coefficient reordering buffer section 13, the CPU 402 reads output coefficients. Therefore, the amount of data held in the coefficient reordering buffer section 13 at the same time becomes less than that in the other examples described above. That is, in this case, the memory capacity required of the coefficient reordering buffer section 13 can be reduced.

It should be noted, however, that in this case, operations must be coordinated between the CPU 401 and the CPU 402, thus requiring a mechanism that controls both the processes executed in the CPU 401 and the processes executed in the CPU 402.

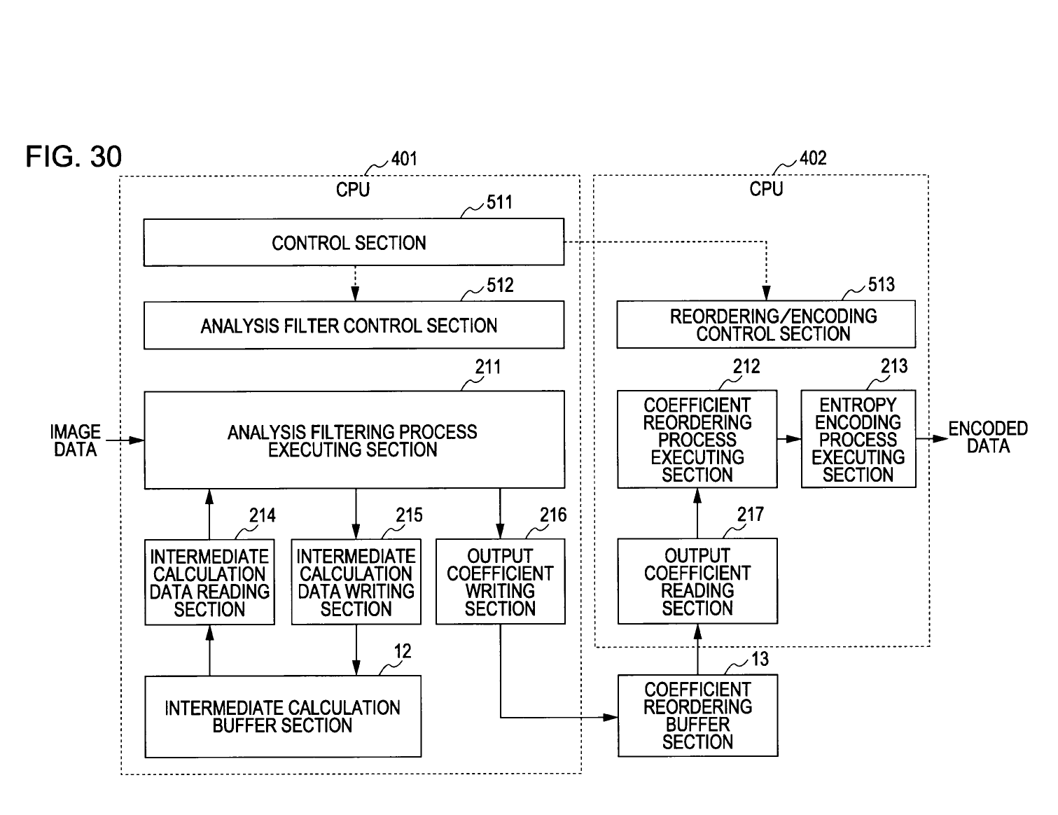

FIG. 30 is a functional block diagram showing functions included in the CPU 401 and the CPU 402 that execute a software program for realizing the encoding section 10 that executes processes in accordance with the above-mentioned flow.

FIG. 30 also corresponds to FIG. 14, and blocks corresponding to the blocks shown in FIG. 14 are denoted by the same reference numerals.

The CPU 401 has functions related to an analysis filtering process, and includes the analysis filtering process executing section 211, the intermediate calculation data reading section 214, the intermediate calculation data writing section 215, and the output coefficient writing section 216. The CPU 402 has functions related to coefficient reordering and entropy encoding, and includes the coefficient reordering process executing section 212, the entropy encoding process executing section 213, and the output coefficient reading section 217.

In FIG. 30, the description is directed to a case where the intermediate calculation buffer section 12 is formed in a cache memory (not shown) of the CPU 401, and the coefficient reordering buffer section 13 is formed in the RAM 404. However, as described above, the intermediate calculation buffer section 12 and the coefficient reordering buffer section 13 can be formed in an arbitrary storage area. It should be noted, however, that to achieve a reduction in load or delay time, it is desirable that the intermediate calculation buffer section 12 that is frequently accessed be formed in the cache memory of the CPU 401 in which an analysis filtering process is performed.

As shown in FIG. 30, like the CPU 101 of the other examples described above, the encoding section 10 shown in FIG. 1 is realized by means of the functional blocks of both the CPU 401 and the CPU 402. That is, the CPU 401 applies an analysis filtering process to image data, and holds the resulting output coefficients in the coefficient reordering buffer section 13. The CPU 402 reads the output coefficients in the order in which they are subjected to a synthesis filtering process, applies an encoding process to each coefficient to generate encoded data, and outputs the encoded data.

The CPU 401 further has a control section 511 and an analysis filter control section 512, and the CPU 402 further has a reordering/encoding control section 513.

The control section 511 controls the operation of the analysis filter control section 512 of the CPU 401 and the operation of the reordering/encoding control section 513 of the CPU 402. The analysis filter control section 512 controls the operations of respective functional blocks of the CPU 401 to perform control related to an analysis filtering process executed in the CPU 401. The reordering/encoding control section 513 controls the operations of respective functional blocks of the CPU 402 to perform control related to coefficient reordering and entropy encoding executed in the CPU 402.

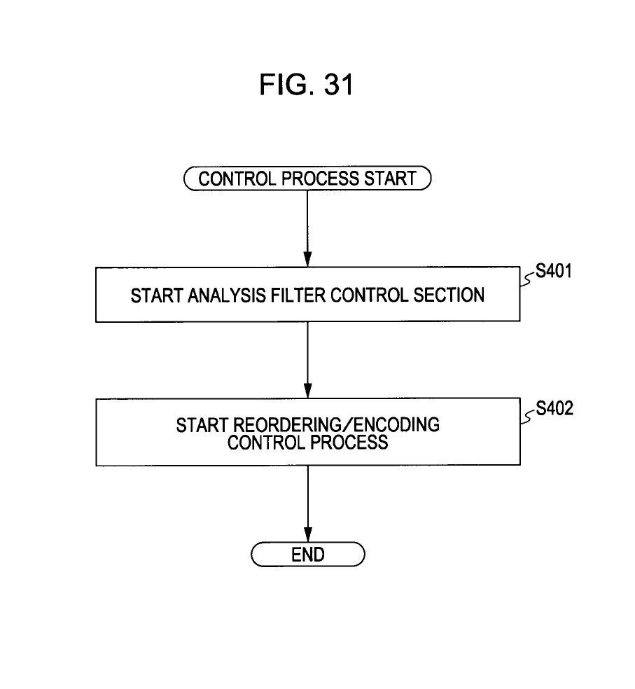

Referring to the flowchart of FIG. 31, a description will be given of an example of the flow of the control process executed by the control section 511. It should be noted that this control process is repeatedly executed for each picture of image data.

When the control process is started, in step S401, the control section 511 controls the analysis filter control section 512 to start an analysis filter control process. Through this control, the analysis filter control section 512 starts the analysis filter control process. The analysis filter control process will be described later. In step S402, the control section 511 controls the reordering/encoding control section 513 to start a reordering/encoding control process. Through this control, the reordering/encoding control section 513 starts the reordering/encoding control process. The reordering/encoding control process will be described later.

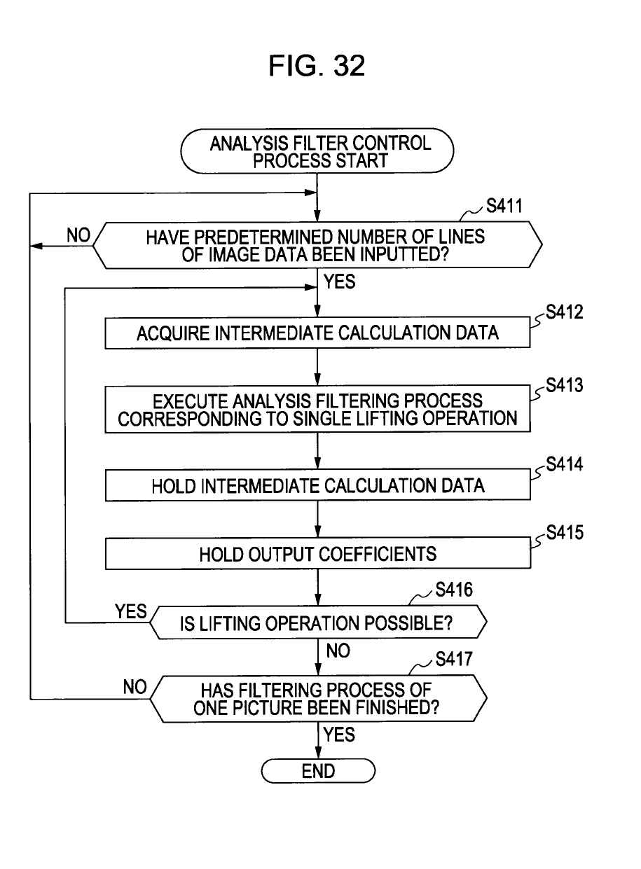

Referring to the flowchart of FIG. 32, a description will be given of an example of the flow of the analysis filter control process executed by the analysis filter control section 512.

When the analysis filter control process is started, in step S411, the analysis filter control section 512 determines whether or not a predetermined number of lines (for example, two or three lines) of image data have been inputted, and waits on standby until it is determined that the predetermined number of lines of image data have been inputted. Then, if it is determined that the predetermined number of lines of image data have been inputted, the analysis filter control section 512 advances the process to step S412.

In step S412, the analysis filter control section 512 controls the analysis filtering process executing section 211 to acquire, from the intermediate calculation buffer section 12, intermediate calculation data necessary for the lifting operation that is going to be performed next. Through this control, the analysis filtering process executing section 211 controls the intermediate calculation data reading section 214 to read, from the intermediate calculation buffer section 12, intermediate calculation data necessary for the lifting operation that is going to be performed next, and to supply the intermediate calculation data to the analysis filtering process executing section 211 (that is, the analysis filtering process executing section 211 acquires intermediate calculation data). Through this control, the intermediate calculation data reading section 214 reads the requested intermediate calculation data from the intermediate calculation buffer section 12, and supplies the read data to the analysis filtering process executing section 211.

In step S413, the analysis filter control section 512 controls the analysis filtering process executing section 211 to execute a single lifting operation of an analysis filtering process. Through this control, as described above with reference to FIG. 28, the analysis filtering process executing section 211 executes a single lifting operation of an analysis filtering process that can be executed.

When the lifting operation is performed, in step S414, the analysis filter control section 512 controls the analysis filtering process executing section 211 to hold, from among image data and coefficient data used in the lifting operation and coefficient data obtained by the lifting operation, those pieces of data which are to be used for the subsequent lifting operations, in the intermediate calculation buffer section 12 as intermediate calculation data. Through this control, the analysis filtering process executing section 211 supplies intermediate calculation data to the intermediate calculation data writing section 215, and also controls the intermediate calculation data writing section 215 to write the supplied intermediate calculation data into the intermediate calculation buffer section 12. Through this control, the intermediate calculation data writing section 215 writes the intermediate calculation data supplied from the analysis filtering process executing section 211 into the intermediate calculation buffer section 12 to be held therein.

In step S415, the analysis filter control section 512 controls the analysis filtering process executing section 211 to hold output coefficients obtained by the lifting operation into the coefficient reordering buffer section 13. Through this control, the analysis filtering process executing section 211 supplies output coefficients to the output coefficient writing section 216, and controls the output coefficient writing section 216 to write the supplied output coefficients into the coefficient reordering buffer section 13. Through this control, the output coefficient writing section 216 writes the output coefficients supplied from the analysis filtering process executing section 211 into the coefficient reordering buffer section 13 to be held therein.

In step S416, the analysis filter control section 512 determines whether or not a lifting operation is possible without input of additional image data. If it is determined that lifting operation is possible, the analysis filter control section 512 returns the process to step S412, and repeats the subsequent processes. That is, as described above with reference to FIG. 28, the analysis filter control section 512 repeats the processes of step S412 to step S416 to perform all the lifting operations that can be executed in correspondence to inputted image data.

Then, if it is determined in step S416 that there are no more lifting operations that can be executed, the analysis filter control section 512 advances the process to step S417. In step S417, the analysis filter control section 512 determines whether or not a filtering process of one picture has been finished. If it is determined that a filtering process of one picture has not been finished, the analysis filter control section 512 returns the process to step S411, and repeats the subsequent processes.

If it is determined in step S417 that an analysis filtering process of one picture has been finished, the analysis filter control section 512 terminates the analysis filter control process.

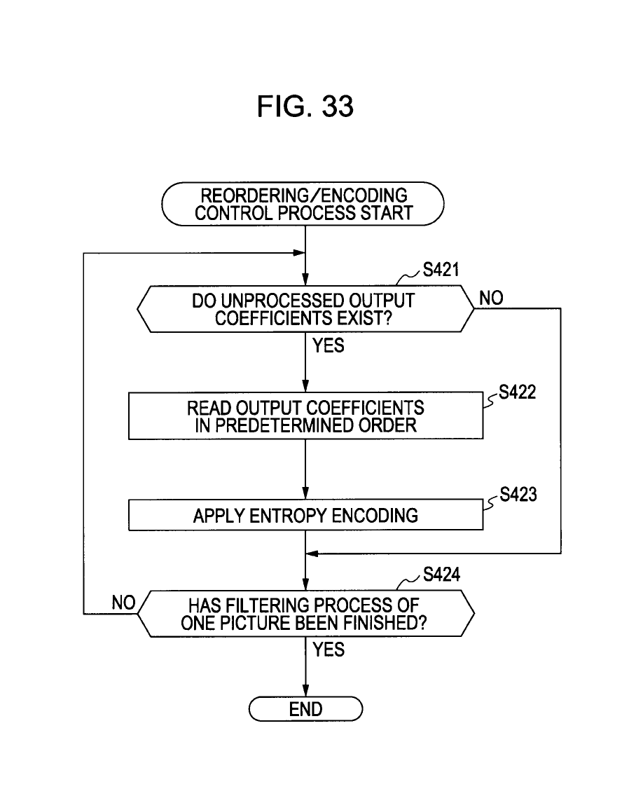

Next, referring to the flowchart of FIG. 33, a description will be given of an example of the flow of the reordering/encoding control process executed by the reordering/encoding control section 513.

When the reordering/encoding control process is started, in step S421, the reordering/encoding control section 513 determines whether or not output coefficients that have not been encoded exist in the coefficient reordering buffer section 13. If it is determined that output coefficients that have not been encoded exist, the reordering/encoding control section 513 advances the process to step S422. In step S422, the reordering/encoding control section 513 controls the coefficient reordering process executing section 212 to read output coefficients held in the coefficient reordering buffer section 13 in a predetermined order. Through this control, the coefficient reordering process executing section 212 controls the output coefficient reading section 217 to read pieces of coefficient data (output coefficients) held in the coefficient reordering buffer section 13 in the order in which they are subjected to a synthesis filtering process, and to supply the read pieces of coefficient data to the coefficient reordering process executing section 212. Through this control, the output coefficient reading section 217 reads pieces of coefficient data held in the coefficient reordering buffer section 13 in the order in which they are subjected to a synthesis filtering process, and supplies the read pieces of coefficient data to the coefficient reordering process executing section 212. The coefficient reordering process executing section 212 sequentially supplies the supplied pieces of coefficient data to the entropy encoding process executing section 213.

In step S423, the reordering/encoding control section 513 controls the entropy encoding process executing section 213 to apply entropy encoding to the coefficient data read from the coefficient reordering buffer section 13. Through this control, the entropy encoding process executing section 213 encodes the read coefficient data, and outputs the obtained encoded data.

Upon finishing the process of step S423, the reordering/encoding control section 513 advances the process to step S424. Further, if it is determined in step S421 that unprocessed output coefficients do no exist, the reordering/encoding control section 513 omits the processes of step S422 and step S423, and advances the process to step S424.

In step S424, the reordering/encoding control section 513 determines whether or not a filtering process of one picture has been finished. If it is determined that a filtering process of one picture has not been finished, the reordering/encoding control section 513 returns the process to step S421, and repeats the subsequent processes.

If it is determined in step S424 that a filtering process of one picture has been finished, the reordering/encoding control section 513 terminates the reordering encoding control process.

By performing the respective control processes as described above, the control section 511, the analysis filter control section 512, and the reordering/encoding control section 513 can execute the wavelet transform process and the entropy encoding process actually in parallel by using two arithmetic processing sections, thereby easily generating encoded data in real time from image data inputted at a predetermined speed and outputting the encoded data.

While in FIG. 27 the description is directed to a case where the number of CPUs is two, the above-described process can be executed even in the case of a personal computer having three or more CPUs. Further, the other control methods described with reference to the drawings prior to FIG. 26 can be executed also in an information processing device having a plurality of arithmetic processing sections like the personal computer 400 shown in FIG. 27.

In the embodiments described above, description is directed to a case where the respective control sections control the respective processing sections from the analysis filtering process executing section 211 to the output coefficient reading section 217. However, the above-described control process may be performed in the respective processing sections from the analysis filtering process executing section 211 to the output coefficient reading section 217. That is, rather than separately providing control sections, the respective processing sections from the analysis filtering process executing section 211 to the output coefficient reading section 217 that actually process data may control each other as appropriate.

While the foregoing description is directed to a case where the wavelet transform process is controlled per each single lifting operation process, and the encoding process is controlled per each process with respect to each piece of coefficient data, control may be performed on the basis of any kind of processing unit that splits each of the wavelet transform process and the encoding process into a plurality of steps. For example, the wavelet transform process may be controlled per processing unit finer than a single lifting operation process, thus performing finer control to achieve a further improvement in the usage frequency of the CPU. Alternatively, the processing unit may be set as every plurality of lifting operation processes, thus further simplifying the control process. Also, for example, the encoding process may be controlled per processing unit finer than each piece of coefficient data, or the processing unit may be set as every plurality of pieces of coefficient data to thereby further simplify the control process.

Further, while in the foregoing description a 5×3 filter is used in the analysis filtering process, any kind of filter may be employed as the filter to be used in the filtering process. For example, a 9×7 filter may be used.

While the series of processes described above can be executed by software, the series of processes can be executed by hardware as well. If the series of processes is to be executed by software, a program constituting that software is installed from a program recording medium into a computer built in dedicated hardware, a general-purpose computer that can execute various functions when various programs are installed into the personal computer, for example, an information processing device of an information processing system made up of a plurality of devices, or the like.

As shown in, for example, FIG. 10 or FIG. 27, this recording medium is configured not only by the removable medium 121 or the removable medium 421 such as a magnetic disk (including a flexible disk), an optical disk (including a CD-ROM (Compact Disk-Read Only Memory) and a DVD (Digital Versatile Disk), a magneto-optical disk (including an MD (Mini-Disk)(R))), or a semiconductor memory in which a program is recorded and which is distributed for delivering the program to the user separately from the device main body, but also by the ROM 102 or the ROM 403, the storage section 113 or the storage section 413, or the like in which a program is recorded and which is distributed to the user while being embedded in the device main body in advance.

It should be noted that in this specification, as a matter of course, the steps describing the program recorded in the recording medium include not only processes that are executed in time series in the order as they appear in the description, but also processes that are not necessarily processed in time series but are executed in parallel or individually.

In this specification, the term system refers to the whole of a device made up of a plurality of devices.

It should be noted that the configuration described above as constituting a single device may be divided into a plurality of devices. Conversely, the configurations described above as constituting a plurality of devices may be combined into a single device. Configurations other than those described above may of course be added to the configuration of each device. Further, as far as the configuration or operation of the system as a whole remains substantially the same, a part of the configuration of a given device may be included in the configuration of another device. That is, an embodiment of the present invention is not limited to the embodiments described above, but various modifications are possible without departing from the scope of the present invention.

What is claimed is:

1. An information processing device comprising:
analysis filtering means for applying to image data an analysis filtering process of decomposing frequency components of the image data into each frequency band by lifting operations;
encoding means for performing an encoding process of encoding the frequency components decomposed into each frequency band by the analysis filtering means; and
control means for controlling execution of the encoding process by the encoding means with respect to each of the frequency components, so that the encoding process with respect to each of the frequency components is executed during a period after the analysis filtering process is finished with respect to a plurality of lines of the image data that are inputted, until a plurality of lines of the next image data are inputted.

2. The information processing device according to claim 1, wherein
the control means executes the encoding process with respect to each of the frequency components during a period after the analysis filtering process is finished with respect to two lines of the image data that are inputted, until two lines of the next image data are inputted.

3. The information processing device according to claim 1, wherein
the control means controls the encoding process of the encoding means so that, of the respective frequency components decomposed into each frequency band by the analysis filtering means, lower frequency components and, within the same frequency band, frequency components that are generated earlier, are encoded earlier.

4. The information processing device according to claim 3, wherein
the control means controls the encoding process by the encoding means so as to encode frequency components generated earlier than the lowest frequency components generated last by the lifting operations.

5. The information processing device according to claim 1, further comprising encoded data holding means for holding encoded data obtained by encoding the frequency components by the encoding means, wherein
the control means causes encoding to be applied earlier than generation of the lowest frequency components by the lifting operations, to frequency components corresponding to the lowest frequency components and higher than the lowest frequency components.

6. The information processing device according to claim 5, wherein
the control means causes the encoded data held in the encoded data holding means to be outputted in a predetermined order, after the lowest frequency components are generated, encoded, and outputted.

7. The information processing device according to claim 1, wherein
the control means controls execution of the analysis filtering process by the analysis filtering means with respect to each of the lifting operations so as to execute the lifting operations that can each be executed every time a plurality of lines of the image data are inputted.

8. The information processing device according to claim 7, wherein
the control means controls execution of the analysis filtering process by the analysis filtering means with respect to each of the lifting operations so as to execute the lifting operations that can each be executed every time two lines of the image data are inputted.

9. The information processing device according to claim 7, wherein
of the lifting operations in the analysis filtering process, lifting operations that generate higher frequency components are executed earlier.

10. An information processing method comprising the steps of:
applying to image data an analysis filtering process of decomposing frequency components of the image data into each frequency band by lifting operations;
performing an encoding process of encoding the frequency components decomposed into each frequency band; and
controlling execution of the encoding process with respect to each of the frequency components, so that the encoding process with respect to each of the frequency components is executed during a period after the analysis filtering process is finished with respect to a plurality of lines of the image data that are inputted, until a plurality of lines of the next image data are inputted.

11. An information processing device comprising:
an analysis filtering section that applies to image data an analysis filtering process of decomposing frequency components of the image data into each frequency band by lifting operations;
an encoding section that performs an encoding process of encoding the frequency components decomposed into each frequency band by the analysis filtering section; and
a control section that controls execution of the encoding process by the encoding section with respect to each of the frequency components, so that the encoding process with respect to each of the frequency components is executed during a period after the analysis filtering process is finished with respect to a plurality of lines of the image data that are inputted, until a plurality of lines of next image data are inputted.
